(19) United States
(12) Patent Application Publication
(10) Pub. No.: US 2026/0064799 A1
(43) Pub. Date: Mar. 5, 2026

(54) COMBINATORIAL OPTIMIZATION ON TENSOR PROCESSORS

(71) Applicant: Groq, Inc., San Jose, CA (US)

(72) Inventors: Johannes Prosser, London (GB); Zarko Bodroski, Novi Sad (RS); Gregory Reynolds Morse, Budapest (HU); Michael Booth, Jackson, TN (US); Peter Rakyta, Budapest (HU)

(21) Appl. No.: 19/313,166

(22) Filed: Aug. 28, 2025

Related U.S. Application Data
(60) Provisional application No. 63/688,652, filed on Aug. 29, 2024.

(51) Int. Cl. G06F 17/11; G06F 17/16

(52) U.S. Cl. CPC G06F 17/11; G06F 17/16

(57) ABSTRACT

The present disclosure relates to systems and methods for obtaining a problem specification file descriptive of a combinatorial optimization problem; identifying a plurality of combinable vector-matrix operations of the combinatorial optimization problem; generating an instruction set for the one or more processors, wherein the instruction set includes a first instruction that, when implemented, causes the one or more processors to perform a combined matrix-matrix operation replacing the plurality of combinable vector-matrix operations; and executing the instruction set.

### CROSS REFERENCE TO PRIORITY APPLICATIONS

The present application claims priority to U.S. Provisional Ser. No. 63/688,652, filed Aug. 29, 2024, the entirety of which is incorporated by reference herein.

### FIELD

The present disclosure relates generally to systems and methods for performing computing operations, such as combinatorial optimization on tensor processors.

### BACKGROUND

Combinatorial optimization is a process of searching for optimal values (e.g., maxima or minima) for an objective function, where a domain of the objective function is a large, discrete configuration space. Combinatorial optimization problems are often viewed as searching for a best element within some set of discrete items. Several conventional algorithms, typically based on linear programming approaches, exist to solve combinatorial optimization problems.

### SUMMARY

Aspects and advantages of embodiments of the present disclosure will be set forth in part in the following description, or can be learned from the description, or can be learned through practice of the embodiments.

One example aspect of the present disclosure relates to a method. The method includes obtaining, by a computing system comprising one or more processors, a problem specification file descriptive of a combinatorial optimization problem. The method includes identifying, by the computing system, a plurality of combinable vector-matrix operations of the combinatorial optimization problem. The method includes generating, by the computing system, an instruction set for the one or more processors, wherein the instruction set includes a first instruction that, when implemented, causes the one or more processors to perform a combined matrix-matrix operation replacing the plurality of combinable vector-matrix operations. The method includes executing, by the computing system, the instruction set.

Another example aspect of the present disclosure relates to a system. The system includes one or more processors and one or more non-transitory, computer-readable media storing instructions that, when implemented, cause the one or more processors to perform operations. The operations include obtaining a problem specification file descriptive of a combinatorial optimization problem. The operations include identifying a plurality of combinable vector-matrix operations of the combinatorial optimization problem. The operations include generating an instruction set for the one or more processors, wherein the instruction set comprises a first instruction that, when implemented, causes the one or more processors to perform a combined matrix-matrix operation replacing the plurality of combinable vector-matrix operations. The operations include executing the instruction set.

Another example aspect of the present disclosure relates to one or more non-transitory, computer-readable media storing instructions that, when implemented, cause one or more processors to perform operations. The operations include obtaining a problem specification file descriptive of a combinatorial optimization problem. The operations include identifying a plurality of combinable vector-matrix operations of the combinatorial optimization problem. The operations include generating an instruction set for the one or more processors, wherein the instruction set comprises a first instruction that, when implemented, causes the one or more processors to perform a combined matrix-matrix operation replacing the plurality of combinable vector-matrix operations. The operations include executing the instruction set.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 is a block diagram of an example processor device according to example implementations of aspects of the present disclosure;

FIG. 2 is a block diagram of an example processor device according to example implementations of aspects of the present disclosure;

FIG. 3 is a block diagram of an example language processing unit device according to example implementations of aspects of the present disclosure;

FIG. 4 is a block diagram of a process according to example implementations of the present disclosure;

FIG. 5 is a block diagram of a system according to example implementations of the present disclosure;

FIG. 6 is a block diagram of a system according to example implementations of the present disclosure; and

FIG. 7 is a flowchart diagram of an example method according to example implementations of the present disclosure.

### DETAILED DESCRIPTION

Example embodiments according to aspects of the present disclosure are directed to systems and methods for combinatorial optimization on tensor processors. According to example aspects of the present disclosure, an engineering optimization problem, which can typically be difficult to execute on a conventional high-performance processor, can be efficiently handled by converting the optimization problem to a sequence of instructions for execution on a tensor processor. One example tensor processor is a “Language Processing Unit” or “LPU.” Consider, for the purpose of illustration, a system having a group of bits, where the bits can have either a zero value or a one value. Furthermore, a system with N bits can be represented mathematically by an N-element vector q, where the i-th element of the vector is indicated by qᵢ. Alternatively, the vector q can represent a set, for example, a set of allocations, where a one value indicates that an element is included in the set, and a zero value indicates that the element is not included in the set.

Furthermore, consider that elements of the system may interact. For instance, a bit may be coupled to another bit, or movement of one element may be correlated to the movement of another element. As another example, a dependency may be present between two or more bits or elements. As another example, bits may be biased towards one of the possible values. These interactions can be represented with coupling matrix Q, where the value of Q_{i,j} represents how much element i affects element j. By making use of the identity

$${q}_{i} = {q}_{i}^{2}$$

the linear biases on the bits qᵢ can be incorporated into the diagonal of Q. Multiplying Q and q element-wise and summing the results of the multiplications (e.g., a mathematical combination of their interactions) creates a result that can represent an optimized solution to the problem:

$${\sum }_{i , j = 1}^{N} {Q}_{i , j} {q}_{i} {q}_{j} .$$

This formulation of the optimization problem is referred to as Quadratic Unconstrained Binary Optimization (QUBO), where ‘quadratic’ refers to the product of the binary elements qᵢqⱼ. For instance, QUBO algorithms may seek a solution minimizing the sum of Σ_{i,j}Q_{i,j}qᵢqⱼ. Many traditional QUBO algorithms employ a brute-force linear programming approach, which may not be practical for large-scale optimization problems in industry. For instance, in one example QUBO algorithm employing local search, only a single bit is changed in each new local search energy calculation. One objective of the QUBO problem is optimizing the symmetric QUBO matrix Q multiplied by the bit vector q for a distribution of the elements of q for each energy for each potential bit change after an initial energy calculation of the matrix times vector (involving N² calculations). The change of energy for a bit flip for a whole vector of energy changes per bit flipped can involve N calculations at a worst case, with these calculations typically involving piecewise scanning the vector of energy changes per bit and recalculation of the vector of energy changes. These types of data manipulation requirements are not easily implementable on matrix-vector processors.

Solving this problem can include determining value(s) of qᵢ result in an optimal (e.g., maximum or minimum) value for the product of Q and q. This operation can be computationally intensive to solve by conventional approaches. For instance, in a system with N bits, there can be 2^{N} possible arrangements or combinations of the bits. Each potential arrangement can involve a vector-matrix multiplication to address. Thus, the number of requisite multiplication operations to solve these problems can rapidly scale with only a relatively small increase in dimensionality. For example, a system with 20 bits (e.g., where N=20) presents 2²⁰ (on the order of magnitude of a million) multiplication operations, which can be addressed by many current desktop computing systems, whereas a system with only ten more bits presents 2³⁰ (on the order of magnitude of a billion) multiplication operations. Some practical environments for these problems (e.g., stock portfolio modeling, particle simulation, etc.) can easily involve 100 or more bits, which presents 2¹⁰⁰ (on the order of 1.2 nonillion) multiplication operations. These operations can be impractical and/or impossible to perform using conventional computing systems, in light of the impractical amount of time, computing resources, energy, and/or latency required to perform these computations. Furthermore, many conventional approximation algorithms and processor designs (e.g., Ising processors, Tabu search, etc.) may fail to provide for a computing system to compute results for increasingly larger values of N, such as systems where N is greater than 100, and/or for other NP-hard problems (where an amount of processing time grows non-polynomially or exponentially with a number of variables). For instance, many known optimization techniques suffer from an exponential growth in processing time for large problems, requiring significant numbers of iterations to find a solution while consuming impractical amounts of power, and thus, in commerce, may be limited to relatively smaller optimization problems. A problem such as modeling the S&P 500, which could involve tracking up to 500 independent parameters, could be intractable to conventional computing systems.

The present disclosure provides a solution to at least this challenge through the use of simulated bifurcation optimization techniques on specialized tensor processors, such as the language processing unit (LPU) (also referred to as a tensor streaming processor (TSP)) available from Groq Incorporated, as described herein. These techniques can be applied to optimization problems involving large (e.g., greater than one hundred) constrained variables, up to significant problems such as those with 500 or more constrained variables. According to example aspects of the present disclosure can provide that matrix-vector operations are batched according to the availability of functional units on a processor to perform matrix-matrix multiplication. For instance, one or more combinable matrix-vector operations can be converted (e.g., batched) into one or more matrix-matrix operations. These combined matrix-matrix operations can be more efficiently implemented by matrix-matrix functional units of a tensor processor. This, for instance, can provide for improved utilization of matrix multiplication (e.g., M×M) functional units on the processor to accelerate operations that may otherwise be computed as relatively slow vector multiplication operations. Furthermore, in some implementations, an extended fixed point representation can be used for accumulation operations in the M×M functional units to efficiently utilize higher-speed SRAM in the processor. These aspects can provide a number of benefits over some existing processors, such as field-programmable gate array (FPGA) processors that may be limited by a number of programmable logic units available for floating point operations. For instance, floating point operations may be challenging to implement on an FPGA processor.

According to example aspects of the present disclosure, an optimization problem with pairing constraints can be formulated as a mixed-integer quadratic programming algorithm utilizing binary variables. The inclusion of linear constraints directly into the objective function can enhance computational performance in solving the optimization problem compared to the exponential scaling of the execution time seen in known optimization algorithms in solving non-convex problems. In particular, according to example aspects of the present disclosure, the linear constraints of the optimization problem can be transformed into quadratic penalty terms. The transformation of equality linear constraints into quadratic penalty terms can be performed by squaring a difference between left and right sides of the constraint.

Additionally and/or alternatively, slack variables can be introduced to inequality constraints in the problem. For instance, the slack variables can be introduced to convert inequality constraints into equality constraints, which can further be transformed into quadratic penalty terms added to the objective function of the optimization. As used herein, a slack variable refers to a variable (typically non-negative) that is introduced to a linear inequality to convert the inequality into a linear equation to make the linear inequality suitable for use in optimization algorithms. Slack variables may be termed as such for representing the “slack” or difference between the two sides of an inequality. Consider, for example, the inequality 2x+3y≤15. There may be multiple solutions for x and y that provide for the equation to be true, presenting challenges for linear optimization. However, introducing a slack variable s and rewriting the inequality as 2x+3y+s=15 provides for the slack variable to represent the difference between 2x+3y and 15. A value of the slack variable can represent how “binding” the constraint is, where a zero value for the slack variable is indicative that the constraint is binding. In some implementations, for example, a binary slack variable labeled by Λᵢ is included into the equation for each inequality, as well as an integer slack variable labeled by Sᵢ. One example encoding introduces a binary and integer slack variable into an equation

$${K}_{min} \leq {\sum }_{i = 1}^{N} {δ}_{i} \leq {K}_{max} , {δ}_{i} = \{ \begin{matrix}0 , & if {h}_{i} < 0 \\ 1 , & otherwise\end{matrix} .$$

Variable Λᵢ encodes whether the associated weight hᵢ of a parameter is zero or not by an equality constraint hᵢ−Λᵢ·(Sᵢ+1)=0 that can be further transformed into a quadratic penalty term (hᵢ−Λᵢ·(Sᵢ+1)) having a minimum at the same place where the equality constraint is also satisfied.

The penalty terms can then be transformed into a QUBO representation of the penalty terms (e.g., represented by a QUBO matrix). For instance, in the example above, the quadratic penalty term can be transformed into QUBO form by substituting variables hᵢ and Sᵢ by respective binary expansions. As used herein, a binary expansion refers to an expression of a number as a sum of powers of two, where the powers are determined by the bits of the number. In the context of the given sub-expression of the optimization problem, the variables hᵢ and Sᵢ are substituted by their binary expansions, which involves expressing these variables as a sum of powers of 2. As one example, the binary expansion of a variable hᵢ is represented as:

$${h}_{i} = {\sum }_{p = 0}^{{p}_{max}} {2}^{p} {h}_{i , p}^{( b )}$$

where pₘₐₓ is the maximum power of 2,

$${h}_{i , p}^{( b )}$$

is the binary coefficient or the p-th power of 2, and the sum is taken over all possible values of p from 0 to pₘₐₓ.

Similarly, the binary expansion of Sᵢ is represented as:

$${S}_{i} = {\sum }_{p = 0}^{{p}_{max}} {2}^{p} {S}_{i , p}^{( b )}$$

where

$${S}_{i , p}^{( b )}$$

is the binary coefficient of the p-th power of 2 for Sᵢ. By expressing the variables in binary expansion form, the quadratic penalty term can be transformed into a Quadratic Unconstrained Binary Optimization (QUBO) form, which can be further processed and optimized using algorithms disclosed herein.

If no sign bit is included in the binary representation (e.g., if neither hᵢ nor Sᵢ are assigned negative values) then the binary value of Λᵢ can be used to determine whether hᵢ is zero or it is greater than zero. For instance, if Λᵢ=0, then the penalty term can be assigned its minimal value 0 only for hᵢ=0, while for Λᵢ=1 a finite value of hᵢ achieves the same effect. In the case where hᵢ>0 the variable Sᵢ, which has no further dependencies during the optimization, is used to offset hᵢ3 s value to guarantee the minimum of the quadratic penalty. The optimization procedure will push the penalty terms to their minimum, thus resolving these relations. Other constraints can similarly be encoded into a QUBO form by transforming the constrained optimization problem into an unconstrained optimization problem.

The QUBO representation can further be transformed into an Ising spin Hamiltonian. The Ising spin Hamiltonian can be applicable in a simulated bifurcation algorithm. For instance, The QUBO and Ising models are connected via a linear transformation Iᵢ=2qᵢ−1 as discussed further below. Simulated bifurcation is an approach for mapping an optimization problem into differential equations used for simulating classical motion of coupled oscillators based on the Hamiltonian equations. In this approach, a QUBO representation of a problem is first transformed into an Ising representation by a linear transformation applied on the elements of q by Iᵢ=2qᵢ−1, where Iᵢ denotes the i-th spin in the Ising problem that can have values of either +1 or −1. Substituting Ising variables in place of QUBO variables into the quadratic optimization formula generates the Ising formulation of the problem Σ_{i,j}IᵢJ_{i,j}Iⱼ+ΣᵢhᵢIᵢ. During the transformation, quadratic QUBO terms diagonal in the QUBO variables can be transformed into linear terms due to the identity

$${q}_{i}^{2} = {q}_{i} .$$

In the next step, the Ising model is mapped onto an optimization problem over continuous variables by replacing the spins with harmonic oscillators with hard-wall inelastic boundary conditions at +1 and −1. The discretized form of the differential equations neglecting higher order terms is represented as:

$${x}_{i} ( {t}_{n + 1} ) = {x}_{i} ( {t}_{n} ) + {y}_{i} ( {t}_{n} ) \cdot δ t$$

$$and {y}_{i} ( {t}_{n + 1} ) = {y}_{i} ( {t}_{n} ) - [ Δ \cdot ( 1 - p ( {t}_{n + 1} ) ) \cdot {x}_{i} ( {t}_{n + 1} ) + 2 {\sum }_{j = 1}^{N} {J}_{i , j} {x}_{j} ( {t}_{n + 1} ) + {h}_{i} ] \cdot δ t .$$

Here, xᵢ and yᵢ represent the generalized position and momentum of the i-th oscillator, δₜ represents the discrete time step, p(t) represents a linear function of the form p(t)=a·t when 0≤t≤1/a and p(t)=0 otherwise, and Δ represents the energy scale of the oscillators. All the quantities in the discretized differential equations can be dimensionless. The optimized spin vector can be derived from the generalized position coordinates via Iᵢ=sgn(xᵢ). The hyperparameters of the model, such as →, a and δₜ can be set according to the reasoning discussed in the section of “Detailed Description”. In some cases, numerical stability after t>1/a can involve including zero diagonals in the J coupling matrix. This can prevent continual oscillation in the oscillators, which can prevent convergence of the variables. There are at least two variations on simulated bifurcation. The differential equations above including boundary conditions −1≤xᵢ<<1 are referred to as ballistic simulated bifurcation (bSB). Another variant of simulated bifurcation is referred to as discrete simulated bifurcation (dSB), obtained by discretizing the spin variables in the second differential equation. This results in a parameter representable by:

$${y}_{i} ( {t}_{n + 1} ) = {y}_{i} ( {t}_{n} ) - [ Δ \cdot ( 1 - p ( {t}_{n + 1} ) ) \cdot {x}_{i} ( {t}_{n + 1} ) + 2 {\sum }_{j = 1}^{N} {J}_{i , j} sgn ( {x}_{j} ( {t}_{n + 1} ) ) + {h}_{i} ] \cdot δ t .$$

These differential equations, while still utilizing matrix-vector multiplications, can be used to find reasonable suboptimal solutions on a much shorter time scale than some conventional search techniques, such as Tabu search. Additionally, simulated bifurcation can be less dependent on manipulating data structures, such as the ‘tabu’ search lists which may not be as amenable to efficient parallel manipulations on tensor processors, which are processors that execute arithmetic operations on large vectors, matrices and higher dimensional arrays, such as graphical processing units (GPUs). While some existing approaches utilize FPGAs to solve simulated bifurcation algorithms, these techniques may be suboptimal, as when N is significantly large, these approaches can involve the use of array partitions that create data flow conflicts. For instance, one approach utilizes a ring topology to communicate data between FPGAs, which may contribute to inefficiencies in moving data between the FPGAs, and contribute to issues when scaled to large problems.

Inputs (e.g., xᵢ and yᵢ) can be cast to a same datatype as a coupling matrix Jᵢⱼ prior to vector-matrix multiplication. Furthermore, a compiler can generate a set of instructions to perform mixed precision arithmetic on the Hamiltonian coupling matrix. These steps can prepare the optimization problem for determining a solution as described further herein.

Once the problem has been formulated as a mixed-integer quadratic programming algorithm, one or more tensor processors can be used to solve the Hamiltonian simulation. The program data and instructions can be stored in a program buffer (e.g., static random access memory or SRAM). Tensors can be updated iteratively while in a memory location in the program buffer. For instance, in some implementations, all program data and instructions can be stored in SRAM. This can provide for a flat memory hierarchy and, therefore, more efficient use of a relatively limited memory. Tensors can be allocated to specific memory addresses within the SRAM and/or iteratively updated in place (e.g., without involving a memory transfer operation). Furthermore, in some implementations, hyperparameters of the Ising model, such as Δ, a and δt, can be combined into single parameters, minimizing the total number of tensors that must be processed or accessed. Additionally and/or alternatively, in some implementations, mathematical operations of each iteration can be rearranged to use the same data flow in multiple logically-separated parts of the algorithm. For example, use of the Δ·δt parameter in different parts of each iteration can be rearranged to utilize a common data flow. This can be used in the element-wise computation of simulated bifurcation.

Furthermore, mathematical operations can be rearranged to use the same data flow as the tensors. One or more vector operations of the QUBO representation can be performed using matrix multiplication (M×M) functional units by the coupling matrix (e.g., as

$${\sum }_{j = 1}^{N} {J}_{ij} {x}_{j} ) .$$

Results can be streamed from the matrix multiplication functional units to the vector multiplication (V×M) functional units. For instance, elements of simulated points described by vectors of generalized position xᵢ and momentum yᵢ can be updated using the vector multiplication functional units.

One computationally significant element of simulated bifurcation is the vector-matrix multiplication of a spin vector S with the coupling matrix J. According to example aspects of the present disclosure, more efficient use of a processor device can be obtained by performing concurrent batches of vector-matrix calculations in simulated bifurcation, such as by performing many concurrent simulated bifurcation operations (e.g., simulations) at once. This can provide for transforming a vector-matrix operation to a matrix-matrix operation, in turn providing for the use of dedicated matrix multiplication functional units, such as M×M units (which can be more efficient than vector-matrix multiplication units or V×M units) thereby improving efficiency. The results of this computation can be streamed directly from the M×M units to the V×M units. This can provide for avoiding unnecessary buffering of results as in some existing dataflow approaches such as using ring topologies.

In some implementations, mixed precision arithmetic can be used for matrix multiplication operations and/or vector multiplication operations. For instance, hyperparameters and vectors can be stored as 32-bit floating point numbers (FP32). Additionally and/or alternatively, the coupling matrix J can be stored as 16-bit floating point numbers (FP16) or 8-bit integers (INT8). This is important as the coupling matrix is the largest tensor in the algorithm. The inputs (i.e. the generalized coordinates x; and moments y; in the discretized differential equations of SB) are cast to the same datatype as the coupling matrix prior to the vector-matrix step outlined above.

Furthermore, in some implementations, the operations can be divided among a plurality of tensor processors. For instance, chip-to-chip (C2C) communications can provide for scaling computations from one tensor processor (e.g., on a card or substrate) to multiple servers. As one example, a single tensor processor can reside inside of an accelerator. The accelerator can be a card or other device (e.g., within the form factor of a peripheral component interconnect express (PCIe) connector) that provides for connections or links between multiple cards. Multiple accelerators can be packaged within a chassis enclosure and/or form at least a portion of a server. Any of a variety of network topologies can be used to configure the arrangement of devices and/or connectors between devices. One example connector provides for multiple devices to cooperatively process programs, extending the determinism of the tensor processors described herein, and/or providing for a plurality of tensor processors to act in concert as a relatively larger compute core. The links can be flow-controlled by software to schedule the transmission of data between chips. This software-scheduled network can provide a synchronous communication backbone with one or more ports on each card for barrier-free communication.

Systems and methods according to some aspects of the present disclosure can provide a variety of technical effects and benefits, such as improvements to computing technology (e.g., tensor processors). For instance, example aspects of the present disclosure can provide for batching vector-matrix operations in a set of operations compiled from a program into matrix-matrix operations, and/or for coordinating the flow of outputs of the batched matrix-matrix operations to vector-matrix functional units as those outputs are available in a deterministic operation schedule compiled from the program. The use of a deterministic operation schedule can provide that, at compile time, the processor can be made aware of exactly which operations will be batched, which batched operations will be performed at which functional units, and/or when results of those operations will be available for downstream processing operations. This, in turn, can provide for improved utilization of the available computing resources on a processor including a plurality of functional units, such as dedicated and/or operation-specific functional units.

One example implementation of the present disclosure can be used to optimize a portfolio of trending data, such as stock pricing data. For instance, one example implementation of the present disclosure provides for financial portfolio optimization (FPO) using simulated bifurcation. Trade Paring is a form of portfolio optimization involving a minimum or maximum number of allowed trades (e.g., busying or selling of stocks in the portfolio) and/or other constraints to minimize transaction costs, minimize disruptions in execution of trades, and/or other suitable constraints. According to example aspects of the present disclosure, a portfolio optimization algorithm with paring constraints can be formulated as a mixed-integer quadratic programming algorithm utilizing binary variables. An example algorithm is given below:

$$\begin{matrix}Maximize & {r}^{T} h - λ {h}^{T} \sum h & & ( 1 ) \\ Subject to : & & & \\ & {e}^{t} h = 1 & ( Holding Constraint ) & ( 2 ) \\ & {L}_{s} \leq Ah \leq {U}_{s} & ( General Linear & ( 3 ) \\ & & Constraint ) & \\ & {L}_{h} \leq h \leq {U}_{h} & ( Asset Bounds ) & ( 4 ) \\ & {K}_{min} \leq {\sum }_{i = 1}^{N} {δ}_{i} \leq {K}_{max} , {δ}_{i} = \{ \begin{matrix}0 , if {h}_{i} < 0 \\ 1 , otherwise\end{matrix} & \begin{matrix}( Asset Paring \\ Constraints )\end{matrix} & ( 5 ) \\ & {T}_{min} \leq {\sum }_{i = 1}^{N} {σ}_{i} \leq {T}_{max} , {σ}_{i} = \{ \begin{matrix}0 , if {h}_{i} - {h}_{0 i} < 0 \\ 1 , otherwise\end{matrix} & \begin{matrix}( Trade Paring \\ Constraints )\end{matrix} & ( 6 ) \\ & \{ \begin{matrix}{h}_{i} \geq ξ or {h}_{i} \leq - ξ or {h}_{i} = 0 \\ {h}_{i} - {h}_{0 i} \geq ζ or {h}_{i} - {h}_{0 i} \leq - ζ or {h}_{i} - {h}_{0 i} = 0\end{matrix} & \begin{matrix}( Level Paring \\ Constraints )\end{matrix} & ( 7 )\end{matrix}$$

where h is a portfolio of vector holdings, r is a vector of asset returns, Σ is an asset-by-asset covariance matrix, and λ is a risk aversion parameter. The asset paring constraints in equation (5) can specify that the number of assets in the optimal portfolio is not greater that Kₘₐₓ or less than Kₘᵢₙ. The trade paring constraints in equation (6) can specify that the number of trades in the trade list is not greater that Tₘₐₓ or less than Tₘᵢₙ. The level holding constraints in equation (7) can set a minimum holding level at ξ and a maximum holding level at ζ. In the example above, for instance, equation (1) can represent a core of the optimization problem (e.g., illustrating competing interests of expected return and risk), equation (2) can represent a constraint on the total budget of the portfolio, and the remaining equations (3)-(7) can represent linear inequality constraints encoding application use cases in commerce.

Another example use case in commerce provides for optimizing a utility function represented mathematically by:

$${\sum }_{t} [ {w}_{t}^{T} {μ}_{t} - \frac{γ}{2} {w}_{t}^{T} {\sum }_{t} {w}_{t} - Δ {w}_{t}^{T} {Λ}_{t} Δ {w}_{t} ]$$

where

$${w}_{t} = [ \begin{matrix}{w}_{1} \\ … \\ {w}_{n}\end{matrix} ]$$

is a weighting vector accounting for capital invested on asset i by an agent studied at time t, μₜ is a return vector which provides the expected value of each asset at time t, Σₜ is the covariance matrix at time t, Λₜ is a matrix modelling the costs of acquisition of the assets at time t, and Δwₜ=wₜ−wₜ₋₁. As illustrated above, this expression presents three key terms:

$${w}_{t}^{T} {μ}_{t}$$

represents the expected return,

$$\frac{- γ}{2} {w}_{t}^{T} {\sum }_{t} {w}_{t}$$

represents risk induced by volatility, and

$$- Δ {w}_{t}^{T} {Λ}_{t} Δ {w}_{t}$$

represents the sum of the costs caused by change in quantity of assets (e.g., brokerage fees). This equation provides a model for rebalancing a stock portfolio by adjusting the weights wᵢ reflecting the amount of stock attributed to a stock i. This weight vector is multiplied twice against a matrix reflecting current statistical property of stock price (e.g., correlations between stock prices) similarly to the Q coupling matrix described above. The present disclosure provides for efficient allocation of these matrix-multiplication operations to a language processing unit to provide efficient computation of these operations.

With reference now to the Figures, example embodiments of the present disclosure will be discussed in further detail.

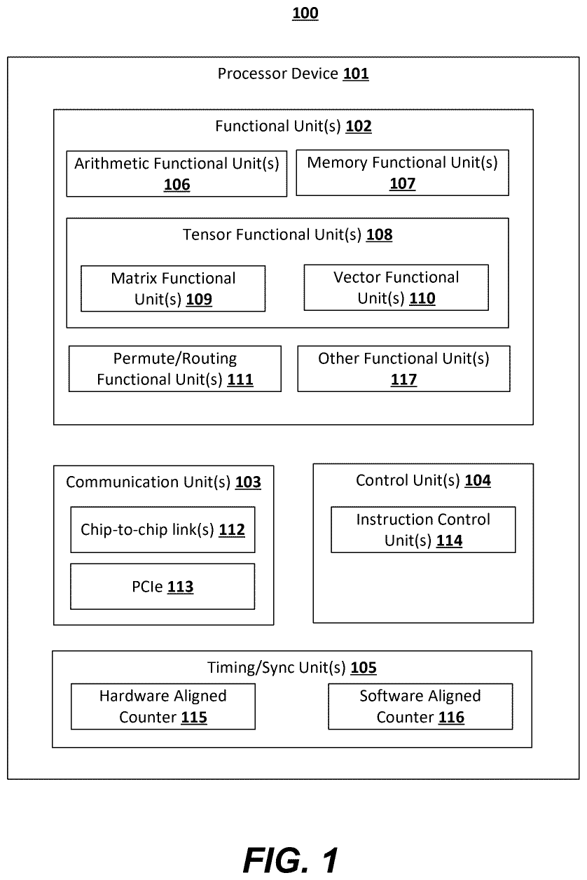

FIG. 1 is a block diagram of an example system 100 including a processor device 101 according to example implementations of aspects of the present disclosure. The processor device 101 can include one or more functional units 102; one or more communication units 103; one or more control units 104 (e.g., instruction control unit(s) 114, etc.); one or more timing or synchronization units 105; or other components. In some instances, functional unit(s) 102 of the processor device 101 can include one or more of: arithmetic functional unit(s) 106; memory functional unit(s) 107; tensor functional unit(s) 108 (e.g., matrix functional unit(s) 109, vector functional unit(s) 110, etc.), permute or routing functional units 111, or other functional units 117. Communication unit(s) 103 can include, for example, one or more of chip-to-chip communication link(s) 112, peripheral component interconnect express 113 components, or other communication unit(s) 103. Timing and synchronization units 105 can include, for example, one or more hardware-aligned counters 115, one or more software-aligned counters 116, or other timing or synchronization component.

A processor device 101 can include various types of processor architectures. In some instances, a processor device 101 can include a single-core or multi-core processor device 101. In some instances, a processor device 101 can include an integrated circuit located on a single die or a processor device 101 distributed over multiple dies connected together (e.g., directly connected such as via face-to-face connection, indirectly connected such as via one or more interposers, etc.). In some instances, a processor device 101 can include one or more of: one or more field-programmable gate arrays (FPGAs); one or more application-specific integrated circuits (ASICs), such as ASICs for machine-learned inference, matrix multiplication, floating-point operations, or the like; one or more graphics processor units (GPUs); one or more tensor processing devices; or other processor type. In some instances, a processor device 101 can include a deterministic processor device or a non-deterministic processor device (e.g., processor device configured to operate according to a deterministic or non-deterministic timing, etc.). In some instances, a processor device 101 can include a processor device having a plurality of dedicated special-purpose functional units, or a processor device having one or more general-purpose functional units (e.g., multi-core processor having a plurality of general-purpose processor cores, etc.). For example, in some instances, a processor device 101 can include a single-core processor device 101 having a plurality of special-purpose functional units 102 having distinct functions, such as functional units 102 having distinct instruction set architectures.

In some instances, a processor device 101 can include a deterministic processor device. A deterministic processor device can include, for example, a processor device configured to perform a plurality of operations according to a predetermined order, such as a predetermined program order defined by a compiler. In some instances, a deterministic processor device can include a processor device configured to perform a plurality of operations according to a predetermined timing or according to a predetermined temporal relationship between operations. For example, in some instances, a deterministic processor can include a processor configured to receive one or more computer-executable instructions (e.g., compiled instructions, etc.) comprising timing data; and execute the instruction(s) according to a predetermined time or predetermined temporal relationship indicated by the timing data. Timing data can include, for example, one or more of: data indicative of a clock cycle on which to execute a particular operation; data indicative of a temporal relationship between one or more first operations and one or more second operations, such as data indicative of a number of clock cycles to pause after a first operation (e.g., data transfer operation, instruction transfer operation, floating-point operation, etc.) is completed before performing a second operation (e.g., floating-point operation, tensor processing operation, etc.); data indicative of one or more operations or instructions configured to have an effect on a timing of operations, such as data indicative of one or more no-operation (NOP) operations or sleep operations, such as a repeated-NOP instruction to cause a functional unit 102 or other component of a processor device 101 to remain idle for a predetermined number of clock cycles; or other timing data.

In some instances, a deterministic processor device can include a processor device configured to receive, from a compiler, a set of computer-executable instructions controlling a timing of a plurality of operations associated with the computer-executable instructions; and perform the plurality of operations according to the timing. For example, in some instances, a deterministic processor device can include a processor device configured to receive a compiled program configured to cause, for each respective operation of a plurality of operations (e.g., arithmetic operations such as floating-point operations, tensor operations, etc.) to be performed on one or more respective data operands (e.g., numerical operands such as machine-learned model parameters, activation values, etc.), an instruction associated with the respective operation to intersect with the respective data operand at a predetermined time instant (e.g., clock cycle, clock cycle offset relative to an initial clock cycle, etc.) defined in the compiled program. In some instances, a deterministic processor can include a processor device having one or more components (e.g., functional unit(s) 102, communication unit(s) 103, etc.) having an instruction set architecture comprising instructions to control a timing of one or more operations of the one or more components.

In some instances, a deterministic processor device 101 can include a processor device configured to route data between functional units 102 of the processor device 101 according to a predetermined timing, predetermined routing or pathing, or both. For example, in some instances, a deterministic processor device 101 can include a processor device configured to receive compiled instructions comprising data indicative of one or more data transfers operations to be performed according to one or more predetermined routes determined by a compiler, according to one or more predetermined timing values defined by the compiler, or both. In this manner, for instance, a deterministic processor device 101 can enable a compiler to perform compile-time load balancing for a plurality of data paths, and can execute a plurality of runtime data transfers according to the compile-time load balancing.

In some instances, a deterministic processor device 101 can include a processor that lacks one or more non-deterministic components that may be commonplace among non-deterministic processor devices, such as branch prediction units, tiered or hierarchical cache devices, runtime load balancing, or other sources of runtime non-determinism (e.g., non-deterministic timing of operations, non-deterministic choice of operations such as non-deterministic routing of data, etc.). For example, in some instances, a processor device 101 can lack any branch prediction components, and can be configured to execute every operation of a compiled program according to a predetermined program order. As another example, in some instances, one or more memory functional units 107 can lack a cache hierarchy or lack any non-deterministic memory component(s). For example, in some instances, one or more memory functional units 107 can be configured to operate deterministically, such as according to a predetermined timing defined by a compiler. For example, in some instances, one or more memory functional units 107 can be configured to perform one or more read operations at one or more times predetermined by a compiler; perform one or more write operations at one or more times predetermined by the compiler; perform one or more refresh operations at one or more times predetermined by the compiler, such that the compiler can have explicit control over a refresh timing of the memory functional unit(s) 107; or the like. For example, in some instances, the compiler can compile a program or other executable into a set of deterministic operations that can be executed by the functional unit(s) 102 at known times specified by a deterministic schedule.

However, although a deterministic processor device 101 can lack some common sources of non-determinism, in some instances, a deterministic processor device 101 can include or interact with one or more non-deterministic components or devices without deviating from the scope of the present disclosure. As a non-limiting illustrative example, in some instances, a deterministic processor device 101 can include a PCIe 113 component configured to perform external input/output (I/O) operations, which can in some instances include input/output operations having a non-deterministic timing (e.g., I/O operations using a non-deterministic PCIe 113 device; I/O operations receiving input from non-deterministic external device(s); etc.). In some instances, a deterministic processor device 101 can interact with non-deterministic component(s) or device(s) (e.g. components or devices internal or external to the processor, etc.), while maintaining deterministic operation of the remaining components of the processor device 101 by designating one or more predetermined time windows to interact with the non-deterministic component(s) in a deterministic manner. For example, in some instances, a processor device 101 can be configured to check, at each of a plurality of predetermined times, whether one or more inputs (e.g., inference request(s), etc.) has been received via a PCIe device 113; and, if the processor device 101 determines that an input has been received, to process the input (e.g., write the input to a designated memory location or region, etc.) according to a predetermined timing or predetermined set of instructions (e.g., according to a set of operations configured to fit within a predetermined time window reserved for non-deterministic external I/O operations, etc.).

In some instances, a processor device 101 can include a processor device configured for single-instruction multiple-data (SIMD) operation. For example, in some instances, a processor device 101 can be configured to receive one or more computer-executable instructions that are each indicative of an operation to be performed on a plurality of operands, such as a vector of numerical operands; a tensor of numerical operands; or the like. In some instances, a SIMD processor device can include a processor device configured to provide a single instruction to a plurality of functional units 102 (e.g., adjacent functional units 102 arranged in a functional region, etc.) to cause each respective functional unit 102 of the plurality of functional units 102 to execute the instruction on one or more distinct operands provided to the respective functional unit 102 (e.g., routed to the respective functional unit 102 according to a predetermined compiler-defined routing, etc.).

In some instances, a processor device 101 can include a single-core processor device, or a processor device configured to operate as a single-core device (e.g., flexible-operation processor device having two hemispheres that can be operated in series as a single-core device or in parallel as a multi-core device, etc.). For example, in some instances, a single-core processor device can include a processor device configured to receive a single set of instructions (e.g., compiled instructions, etc.) and to execute, in a serial or pipelined fashion using one or more functional units 102, a set of operations defined by the single set of instructions. For example, in some instances, a single-core processor device 101 can include a processor device configured to obtain (e.g., receive, retrieve, etc.) one or more instructions (e.g., SIMD instructions, etc.) indicative of a plurality of operations (e.g., plurality of SIMD operations, etc.) to be performed on one or more operands; and perform, in series using a plurality of functional units 102, the plurality of operations (e.g., SIMD operations wherein each operation is a multiple-data operation, etc.) on the one or more operands.

Functional unit(s) 102 can include, for example, one or more components (e.g., integrated circuit components, etc.) configured to perform operations on one or more operands (e.g., data operands, etc.). In some instances, functional unit(s) 102 can include deterministic functional units 102, such as deterministic functional units configured to perform one or more operations in a predetermined program order, according to a predetermined timing or temporal relationship, or the like. In some instances, a set of functional units 102 can include a plurality of dedicated or special-purpose functional units 102, such as distinct functional units 102 having distinct functions or sets of functions (e.g., limited or specialized function sets, etc.). In some instances, functional unit(s) 102 can include functional units configured to perform multiple operations per instruction for at least some instructions, such as single-instruction multiple-data (SIMD) functional unit(s) 102, and/or functional unit(s) 102 configured to process instruction(s) directed to multiple computing operations (e.g., multiple repetitions of a single type of operation, pipeline of multiple different operations, etc.).

In some instances, a set of dedicated functional unit(s) 102 can include distinct dedicated functional units 102 for each of a plurality of steps in a machine-learned inference pipeline, such as a distinct dedicated functional unit for each component of a category or type of machine-learned model layer (e.g., convolutional layer, attention layer, fully connected layer, etc.). For example, in some instances, a set of dedicated functional units 102 for implementing a fully connected layer of a machine-learned model can include one or more matrix functional units 109 for performing matrix multiplication between a parameter tensor (e.g., weight matrix, etc.) and a tensor (e.g., vector, etc.) of input values to the fully connected layer, and one or more vector functional units 110 for performing an activation function of the fully connected layer. As another example, in some instances, a set of dedicated functional units 102 for implementing a convolutional layer of a machine-learned model can include one or more permute/routing functional units 111 configured to perform one or more data reshaping operations corresponding to one or more convolutions (e.g., two-dimensional convolutions, one-dimensional convolutions, etc.); and one or more other functional units 102 (e.g., matrix functional unit(s) 109, vector functional unit(s) 110, etc.) for performing additional operations associated with a convolutional layer or convolutional neural network (e.g., matrix multiplication, pooling, activation functions, etc.).

In some instances, a plurality of dedicated functional units 102 can include a first functional unit 102 configured to perform a set of operations that is different (e.g., completely disjoint from or partially overlapping, etc.) from a second set of operations associated with a second functional unit 102. In some instances, a plurality of special-purpose or dedicated functional units 102 can have a plurality of distinct instruction set architectures, such as limited or special-purpose instruction set architectures each supporting a limited or special-purpose set of operations. As a non-limiting illustrative example, in some instances, a set of dedicated functional units 102 can include one or more of: a matrix functional unit 109 configured to perform a first set of matrix operations (e.g., matrix multiplication operations, etc.); a vector functional unit 110 configured to perform a set of vector operations different from the matrix operations (e.g., activation function operations such as rectified linear unit (ReLU), sigmoidal, softmax, or other activation function operations; normalization operations; etc.); a permute/routing functional unit 111 configured to perform one or more data routing, data permutation, or data reshaping functions (e.g., tensor permutation or reshaping, etc.) different from the matrix operation(s) and different from the vector operation(s); or other dedicated functional unit(s) 102. Other examples are possible.

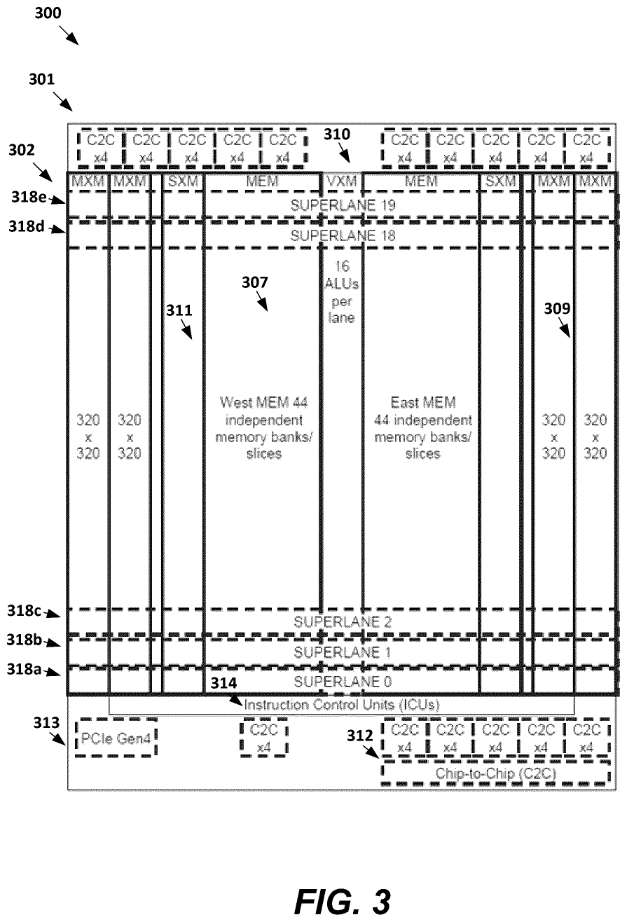

In some instances, functional unit(s) 102 can include functional units organized into functional regions of a processor die, such as compact functional regions configured to facilitate low-latency propagation of instructions or operands within a functional unit 102 or between adjacent functional units 102. As a non-limiting illustrative example, in some instances, one or more functional units 102 can be organized into functional slices along a first axis of a processor die, thereby enabling low-latency propagation of one or more instructions along the axis, low-latency propagation of operand data along a second axis, or the like. Further details of an example processor device comprising functional slices are provided below with respect to FIG. 3.

In some instances, functional unit(s) 102 or functional region(s) can be geographically organized on a processor die to reduce (e.g., minimize or nearly minimize; reduce relative to a random arrangement or relative to a conventional multi-core central processing unit or conventional graphics processing unit, etc.) a communication cost (e.g., latency cost, power cost, communication distance, etc.) associated with one or more computational pipelines, such as machine-learned inference pipelines. For example, in some instances, one or more functional units 102 or functional regions of a processor device 101 for performing a sequentially first operation in a computational pipeline can be geographically close to one or more functional units 102 for performing a sequentially second operation in the computational pipeline. Example computational pipelines can include, for example, inference pipelines associated with common machine-learned model, layer, or head architectures, such as convolutional architectures; attention architectures; fully connected layer architectures; selective structured state space machine architectures; gating architectures (e.g., long short-term memory, etc.); or another machine learning architecture.

In some instances, functional unit(s) 102 can include functional units configured to perform multiple operations per instruction for at least some instructions, such as single-instruction multiple-data (SIMD) functional unit(s) 102 or functional units 102 configured to operate without necessarily receiving explicit instructions for each operation. For example, functional unit(s) 102 configured to operate without necessarily receiving explicit instructions for each operation can include one or more of: functional unit(s) 102 configured to receive intermittent instructions and perform multiple operations per instruction (e.g., repeated single operation, pipeline of multiple different operations, etc.); functional unit(s) 102 configured to operate without instructions according to a default operation; or the like. In this manner, for instance, an amount of communication required to provide instructions to the functional units 102 can be reduced, and operation of the processor device 101 can in some instances be simplified compared to some alternative implementations.

For example, in some instances, a SIMD functional unit 102 can include a tensor functional unit 108 configured to execute an instruction on a plurality of numerical values, such as a vector or matrix of numerical values. For example, in some instances, a tensor functional unit 108 can be configured to receive an instruction; and process, according to the instruction, a tensor (e.g., one-dimensional vector tensor, two-dimensional matrix tensor, etc.) comprising a plurality of numerical values (e.g., dozens of numerical values per instruction, such as hundreds, such as 320 numerical values in some examples described below with respect to FIG. 3). In some instances, a tensor functional unit 108 can be configured to process some or all of a plurality of values simultaneously, or to execute a single-instruction multiple-data instruction according to a staggered timing.

As another example, in some instances, a functional unit 102 configured to operate based on intermittent instructions can include a functional unit 102 configured to repeat one or more operations, such as a functional unit 102 configured to continue performing a given operation (e.g., an operation associated with a most recently received instruction, etc.) periodically (e.g., at every clock cycle; at every Nth clock cycle; etc.) for some amount of time (e.g., indefinitely, for a finite period of time such as a time period defined by a previously received instruction, etc.) in the absence of explicit instructions. In some instances, a functional unit 102 can include a functional unit 102 configured to receive and execute one or more repetition instructions (e.g., having an instruction set architecture comprising one or more repetition instructions, etc.). A repetition instruction can include, for example, an instruction to cause the functional unit 102 to repeat (e.g., repeat at every clock cycle; at every Nth clock cycle, where N can be a parameter of the instruction; etc.) a previous instruction or set of instructions a number of times specified by the instruction; an instruction indicative of an operation to be repeated (e.g., arithmetic operation, matrix operation, vector operation, etc.), the instruction having a repetition parameter indicating a number of times to repeat the operation; or the like. In some instances, a repetition instruction can include one or more offset parameters, such as a time offset parameter (e.g., number of cycles to wait between repetitions, etc.), location offset parameter indicative of a distance between consecutive locations (e.g., functional unit 102 location, memory location, data path location, etc.) associated with a repeated operation, or other offset parameter.

As another example, in some instances, a functional unit 102 can include a functional unit 102 configured to receive a single instruction indicative of multiple distinct operations to be performed on a single operand or set of operands, such as a multiply-accumulate (MACC) instruction or matrix multiplication instruction indicative of one or more multiply operations and one or more accumulate operations to be performed on one or more outputs of the multiply operation(s). In some instances, a functional unit 102 can include a pipelined hardware architecture (e.g., systolic array pipelined hardware, deterministic streaming hardware such as hardware having one or more properties described with respect to FIG. 3, etc.) configured to provide (e.g., directly; indirectly via one or more buffers, registers, or other memory components; etc.) an output of one or more first hardware devices (e.g., floating-point units, etc.) for performing earlier (e.g., sequentially first, etc.) operations of a multi-operation instruction to an input of one or more second hardware devices for performing later (e.g., sequentially second or last, etc.) operations of the multi-operation instruction. In some instances, a pipelined hardware architecture of a functional unit 102 can include a geographically compact architecture, wherein a plurality of components for performing a multi-operation instruction can be adjacent or otherwise close together on a processor die.

An arithmetic functional unit 106 can include, for example, one or more functional units 102 for performing various arithmetic operations, such as floating-point operations, integer operations, or quantized operations; simple operations (e.g., add, multiply, format conversion, etc.) or complex/combined operations (e.g., multiply-accumulate, etc.); single-operand operations or multi-operand operations (e.g., tensor operations, etc.); or other arithmetic operations. In some instances, an arithmetic functional unit 106 can be a tensor functional unit 108 or component thereof, or have one or more properties described below with respect to tensor functional unit(s) 108.

A memory functional unit 107 can include, for example, one or more functional units 102 for reading, writing, or storing various kinds of data, such as operand data, instruction data, or other data. Data storage can include, for example, temporary storage of one-time-use or ephemeral values (e.g., computed operand values, etc.), longer-term storage of values to be reused (e.g., machine-learned model weights, compiled computer-executable instructions, etc.), or other storage. In some instances, a memory functional unit 107 can include one or more low-latency, high-bandwidth, or otherwise rapidly accessible memory devices, such as random access memory (RAM) devices (e.g., static random access memory (SRAM), high-bandwidth memory (HBM), dynamic random access memory (DRAM), etc.), registers, or other low-latency devices.

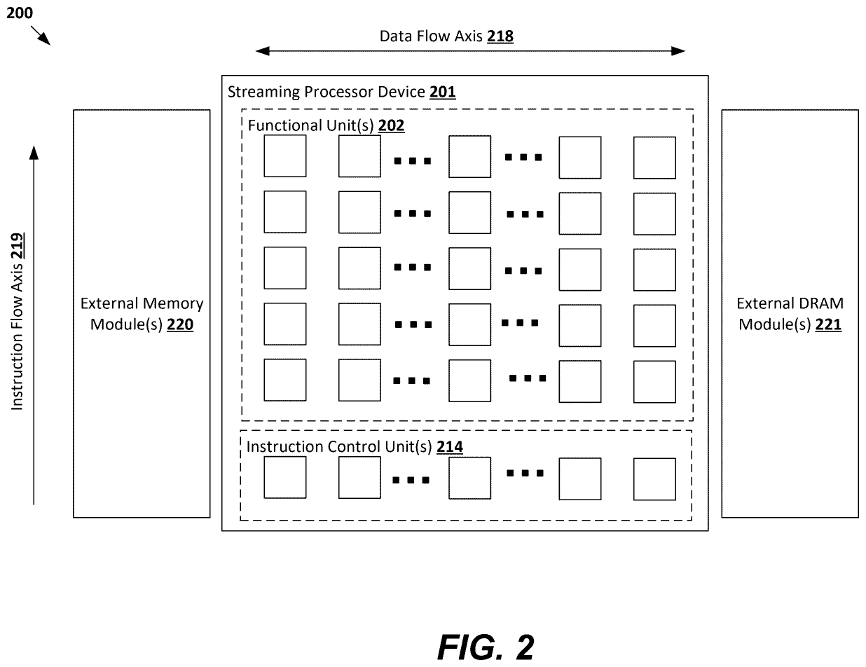

In some instances, one or more memory functional units 107 can be configured to share a global address space accessible to a plurality of functional units 102. For example, in some instances, a global address space can include all memory locations available to the processor device 101 (e.g., including any external memory modules, etc.), such that any functional unit 102 of the processor device 101 can obtain (e.g., receive at a predetermined time defined by the compiler, such as without requiring the functional unit 102 to output any request for the data obtained). In some instances, a set of memory functional unit(s) 107 can include, or a processor device 101 can have access to, one or more internal (e.g., on-chip) memory functional units 107; one or more external (e.g., off-chip, near-compute, etc.) memory units; or both. Further details of some example near-compute external memory units are provided below with respect to FIG. 2, while details of some example on-chip memory units are provided below with respect to FIG. 3.

A tensor processing unit 108 can include, for example, a functional unit 102 to perform one or more operations (e.g., arithmetic operations such as tensor multiplication, elementwise multiplication, normalization, activation function operations, etc.) on one or more tensors (e.g., matrices, vectors, etc.). In some instances, a tensor processing unit 108 can include a matrix functional unit 109; a vector functional unit 110; or another functional unit.

A matrix processing unit 109 can include, for example, a functional unit 102 configured to perform one or more operations on a matrix (e.g., two-dimensional matrix, flattened matrix, etc.) of operands (e.g., numerical values such as floating-point values, etc.). In some instances, a matrix processing unit 109 can include a functional unit 102 configured to perform matrix multiplication or other matrix operations.

A vector processing unit 110 can include, for example, a functional unit 102 configured to perform one or more operations on a vector (e.g., one-dimensional vector, flattened tensor, etc.) of operands (e.g., floating-point numerical values, etc.). In some instances, a vector processing unit 110 can include a functional unit 102 configured to perform one or more of: one or more activation function operations (e.g., sigmoidal or logistic activation function, linear unit activation function such as rectified linear unit (ReLU), softmax activation function, etc.), one or more normalization operations (e.g., L2 normalization, etc.), one or more combining operations (e.g., attention-based combining, etc.) to combine a set (e.g., pair, trio, etc.) of vectors, one or more constituent operations configured to be combined to support a class of related operations (e.g., class or category of normalization operations, class or category of activation function operations, etc.), or the like.

A permute/routing functional unit 111 can include, for example, a functional unit 102 configured to perform one or more data permuting or data routing operations. In some instances, a data permuting operation can include one or more swap or reordering operations configured to reorder data in an ordered format (e.g., vector format or other tensor format; ordered arrangement of registers, signal lines, or other hardware units; etc.), such as without changing a shape (e.g., length, width, number of dimensions, etc.) of the ordered format. Example reordering operations can include, for example, rotation or translation operations; arbitrary reordering operations defined by one or more reordering maps such as a gather map; or other reordering operations. In some instances, a data permuting operation can include a reshaping operation, such as a reshaping operation changing a number of dimensions of a data structure (e.g., tensor, hardware devices corresponding to a tensor, etc.), changing a size of one or more dimensions of the data structure, or the like. As a non-limiting illustrative example, in some instances, a reshaping operation can include a tensor flattening operation to convert a multi-dimensional tensor into a one-dimensional data structure (e.g., vector, hardware configuration corresponding to a vector, one-dimensional data stream corresponding to a vector, etc.). As another example, in some instances, a reshaping operation can include an expansion or duplication operation, such as a reshaping operation to generate an expanded convolutional kernel to implement a filter component of a convolutional neural network. In some instances, a routing operation can include a permuting operation to change an ordering of operands input to one or more fixed or predetermined data paths, or another routing operation (e.g., switching operation; pair of operations comprising a send and a receive; etc.). In some instances, a permuting operation can include a routing operation to change a routing of operands to hardware having a fixed or predetermined input order.

In some instances, a memory functional unit 107; a tensor, matrix, or vector functional unit 108, 109, 110; or a permute/routing functional unit 111 can be or include a deterministic functional unit 102 configured to execute instruction(s) at a predetermined time defined by a compiler; a single-instruction multiple-operation functional unit 102 configured to perform a plurality of operations based on one instruction; or have any other property described herein with respect to functional unit(s) 102. Further details of some example functional units 107, 109, 110, 111 are provided below with respect to FIG. 3.

Communication units 103 can include various components for performing communication operations (e.g., input, output, etc.) between the processor device 101 and other devices (e.g., processor devices, computing devices, external memory devices, etc.) or components, or within the processor device 101. In some instances, communication units 103 can include deterministic communication units (e.g., communication units performing operations according to a predetermined program order, timing, temporal relationship, or other predetermined property, etc.), non-deterministic communication units (e.g., communication units having non-deterministic timing properties, communication units configured to communicate with non-deterministic external devices, etc.), or both. For example, in some instances, a deterministic processor device 101 can include a plurality of deterministic chip-to-chip communication links 112 configured to communicate with other deterministic processor devices 101 (e.g., using deterministic communication operations having a predetermined timing, communication path, or other property), along with one or more PCIe components 113 configured to interact with one or more non-deterministic components. In some instances, communication units 103 can include or have access to various components, such as serializer-deserializer (SerDes) units configured to serialize data to be output or deserialize data received as input; communication ports, connections, interface units, or the like; communication lines (e.g., electrically conductive signal traces, electrically conductive wires, optical fibers, cables, etc.); routing or data permutation components (e.g., internal routing or permutation components such as switching components; external components coupled to the processor device 101 such as routers, repeaters, switches, panels, or the like); or other components configured to facilitate one or more communication operations.

Chip-to-chip communication units 112 can include, for example, any device or component for communicating with another processor device (e.g., processor device 101, etc.), such as one or more serializer-deserializer units, one or more communication channels (e.g., signal lines, etc.), one or more connection components (e.g., ports, pins, connection pads, etc.), or the like. In some instances, a processor 101 can include a plurality of chip-to-chip communication ports to facilitate direct communication with a plurality (e.g., four, eight, sixteen, etc.) of other chips, such as according to a high-radix chip-to-chip communication topology (e.g., dragonfly topology, hyperX topology, etc.), such as a topology having greater than or equal to eight chip-to-chip communication links per processor device 101. In some instances, chip-to-chip communication units 112 can include units configured to communicate with processor devices that are geographically close to or far away from the processor device 101 (e.g., in a same or different compute node as the processor device 101; in a same or different rack; etc.). In some instances, chip-to-chip communication units 112 can include connections to a plurality of distinct chips, a plurality of connections to a single chip, or both. In some instances, chip-to-chip communication units 112 can include chip-to-chip communication units 112 associated with one or more bidirectional communication channels, one or more unidirectional communication channels, or both. In some instances, chip-to-chip communication units 112 can include deterministic communication units configured to perform chip-to-chip communication operations (e.g., send operation, receive operation, etc.) at one or more times predetermined by a compiler; deterministic communication units having a known or deterministic timing for one or more data transfer operations; or the like. In some instances, one or more timing units 105 can be used to provide synchronization for one or more processor devices 101 to facilitate deterministic-timing communication between chips.

A peripheral component interconnect express (PCIe) component 113 can include, for example, a communication device configured to facilitate communication between a processor device 101 and one or more other devices (e.g., computing devices; processor devices; data storage devices; auxiliary devices; etc.). In some instances, a PCIe unit 113 can include a communication system conforming to one or more PCIe communication standards (e.g., PCIe 6.0, PCIe 7.0, etc.). Although FIG. 1 depicts a PCIe unit 113, other communication units or communication standards can be used without deviating from the scope of the present disclosure. In some instances, a processor device 101 can include a deterministic processor device 101 configured to communicate non-deterministically via the PCIe unit 113 while maintaining determinism in the functional unit(s) 102 of the processor device 101 (e.g., according to methods described above).

In some instances, control unit(s) 104 can include one or more devices for controlling one or more operations of the functional unit(s) 102, such as device(s) configured to supply one or more control signals (e.g., assembly code or machine code instructions; switching signals, multiplexer selection signals, etc.) to one or more functional unit(s) 102.

In some instances, control unit(s) 104 can include one or more instruction control unit(s) 114 configured to supply computer-executable instruction(s) to one or more functional units. In some instances, an instruction control unit 114 can include a deterministic instruction control unit 114 configured to supply instruction(s) to the functional unit(s) 102 according to a predefined program order determined by the compiler; supply instruction(s) at one or more predefined times (e.g., clock cycles, etc.); or the like. In some instances, an instruction control unit 114 can include hardware configured to fetch (e.g., prefetch, etc.) instruction(s) from memory at a first time (e.g., before the instructions are needed; during a time of off-peak memory usage; at a time predetermined by a compiler; etc.) and provide corresponding instruction(s) to one or more functional unit(s) 102 at a second time (e.g., second time predetermined by the compiler, etc.)

In some instances, instruction(s) provided to a functional unit 102 by an instruction control unit 114 can be the same as or different from a corresponding instruction received by the instruction control unit 114. For example, in some instances, an instruction control unit 114 can include a unit configured to translate one or more compiled instructions (e.g., instructions in a first computing language or format output by a compiler, etc.) to one or more control signals (e.g., instructions in a second language or format; other control signals such as multiplexer selection signals or the like). In some instances, translating compiled instructions can include translating a memory-efficient stored instruction to a plurality of control signals that may include a greater data volume than the memory-efficient stored instruction. For example, in some instances, translating compiled instructions can include retrieving, from a memory functional unit 107, a compiled instruction; and providing, based on the compiled instruction, a plurality of control signals to one or more (e.g., a plurality of) functional units 102 over one or more (e.g., a plurality of) clock cycles. In some instances, a memory-efficient stored instruction can include a multi-operation instruction associated with a plurality of related operations (e.g., operations of a machine-learned model layer such as matrix multiplication, activation functions, convolution, attention, or the like), and the translated control signals can include a plurality of control signals (e.g., lower-level instructions, etc.) for executing the multi-operation instruction. In some instances, an instruction control unit 114 can include hardware configured to receive an instruction comprising one or more timing parameters (e.g., delay amounts, etc.) or repetition parameters, and output control signal(s) to the functional unit(s) 102 to cause the functional units to perform operations according to the timing or repetition parameters (e.g., at a predetermined clock cycle defined by a compiler, etc.). In some instances, the instruction control unit 114 can control a timing or a number of repetitions of the functional unit(s) 102 by sending control signals comprising timing or repetition data, or by sending raw control signals at a specific time or plurality of times configured to cause the functional unit(s) 102 to perform operations according to one or more timing or repetition parameters.

In some instances, timing and synchronization units 105 can include various components configured to perform synchronization operations, such as operations to track or communicate time data (e.g., current clock cycle data, etc.) to one or more functional units 102 or other components of a processor device 101. In some instances, timing and synchronization units 105 can include one or more of: one or more hardware-aligned counters 115, one or more software-aligned counters 116, or other timing or synchronization component.

Hardware aligned counters 115 may be used to establish a time base for electronic circuitry in each system, such as a clock, for example. Additionally, each system may include software aligned counters 116. Software aligned counters 116 may be synchronized, for example, based on one or more computer-executable instructions (e.g., compiled instructions determined by a compiler, etc.). Hardware aligned counters 115 and software aligned counters 116 may be implemented as digital counter circuits, for example, on each integrated circuit (e.g., each processor device 101 or each die thereof, etc.). For instance, hardware aligned counters 115 may be free-running digital counters (e.g., 8-bit counters) on a processor device 101 that are synchronized periodically. Similarly, software aligned counters 116 may be digital counters (e.g., 8-bit counters) that synchronized based on timing markers triggered by one or more compiled programs.

In some instances, timing and synchronization units 105 can include one or more components 105 for internal synchronization of a plurality of components (e.g., functional units 102, etc.) of a processor device 101; one or more components 105 for external synchronization between a first processor device 101 and one or more other devices (e.g., a plurality of second processor devices 101, etc.); or both.

In some instances, synchronizing a first device (e.g., first processor device 101 or another device) with a second device (e.g., second processor device 101 or another device, etc.) can include, for example, synchronizing one or more hardware aligned counters 115 of the first processor device 101 with one or more hardware aligned counters of the second device. Synchronizing the hardware aligned counters 115 may occur periodically during the operation of each system and may occur at a higher frequency than synchronizing software counters 116, for example. Synchronizing hardware counters may include the first device sending a timing reference (e.g., timing bits representing a time stamp) to the second device over a communication channel (e.g., via chip-to-chip communication units 112, etc.). In some instances, a first system may send an 8-bit time stamp, for example. In such a scenario, a hardware counter 115 and software counter 116 of the first device may be maintained in sync locally. However, as the hardware counter 115 on a second device is synchronized to the hardware counter 116 on a second device, the software counter 116 on the second device may drift.

In some instances, software aligned counters 116 of a pair of devices can be synchronized by providing, in each of the devices (e.g., as part of a compiled program executed by the devices, etc.), one or more timing markers configured to be sequentially triggered (e.g., at predetermined positions in a compiled program corresponding to particular points of time or particular cycles). In some instances, timing markers in each device may be configured to trigger on the same cycle in each system. For example, a first program on a first device may trigger a timing marker on the same cycle as a second program on a second device when the devices' hardware aligned counters 115 are synchronized. In some instances, these timing markers may be used to synchronize software counters 116 of both devices. For example, in some instances, timing differences between the timing markers may correspond to a time difference indicative of a degree to which the two devices are out of synchronization, and synchronization can include adjusting a timing of one or more operations based on the time difference. For example, in some instances, a software aligned counter 116 can perform one or more delay operations at each of a plurality of timing markers, and a length of the delay can be adjusted based at least in part on a time difference between the first and second device at the timing marker. However, same-cycle timing is not required; for example, in some instances, a pair of timing markers may be offset by a known number of cycles, which may be compensated for during the synchronization process (e.g., by using different fixed delays, etc.).

In some instances, a timing difference (e.g., number of cycles, etc.) between timing markers may be constrained within a range. For example, a minimum time difference between timing markers in a first and second device may be based on a time to communicate information between the devices (e.g., a number of cycles greater than a message latency), and a maximum time difference between timing markers in the devices may be based on a tolerance of oscillators forming the time base on each system (e.g., if the time difference increases beyond a threshold for a given time base tolerance, it may become more difficult or impossible for the systems to synchronize for a given fixed delay). The minimum and maximum number of cycles may also be based on the size of a buffer (e.g., a first in first out (FIFO) memory) in each chip-to-chip communication circuit, for example.

In some instances, synchronizing hardware aligned counters 115 of a pair of devices can include sending, by a first device at a first time to, a timing reference; and receiving, at a second time t₁ by a second device, the timing reference. In some instances, the latency of such a transmission may be characterized and designed to be a known time delay Δt=t₁−t₀. In such instances, synchronizing the pair of devices can include setting, by the second device, a hardware aligned counter 115 to a value of (t₀+Δt) such that the hardware aligned counters 115 of both devices are synchronized.

In some instances, although the first and second devices can be architecturally similar (e.g., same) or different, synchronizing the devices can include, for example, assigning a first device as a designated sender device to send timing data, and designating a second device as a designated receiver device to receive timing data and adjust a timing of the receiver device's operations based on the timing data.

In some instances, software aligned counters 116 can be synchronized in a manner similar to synchronization of hardware aligned counters 115. For example, in some instances, a software aligned counter 115 can include or implement one or more timing triggers comprising one or more delays (e.g., no-operation (NOP) delays, etc.), wherein a plurality of devices are configured to perform a synchronized delay, such that one or more operations performed after the synchronized delay may be synchronized. For example, in some instances, a first device may send timing data to a second device at t0; and perform a predefined delay operation until t1. A second device may receive the timing data at (t0+Δt); and determine, based on the timing data, an amount of delay (e.g., number of clock cycles, etc.) to cause the second device to resume operations at t1.

In some instances, synchronization can include fine synchronization (e.g., as described above), coarse synchronization, or both. For example, during various points in operation, the first and second systems may be far out of sync. For example, during startup or after a restart (collectively, a “reset”), a set (e.g., pair, etc.) of devices may perform a coarse synchronization (e.g., using a 20-bit digital counter, etc.) to bring the time bases close enough so they can be maintained in alignment using the techniques described above (e.g., within a resolution of the hardware and software counters, such as 8 bits).

In some instances, synchronizing a number of devices greater than two can include performing similar operations with more than two devices, such as pairwise synchronizations at staggered times, such as pairwise synchronization of a processor device 101 with each of a plurality of neighbors in a chip-to-chip communication topology at a plurality of respective times; one-to-many (e.g., one-to-all, etc.) broadcasting of timing data; pairwise propagation of timing data between pairs of devices according to a propagation pattern or communication topology; or other mechanism for sending and receiving timing data and updating a timing of operations based on the timing data.

FIG. 2 is a block diagram of a system 200 including an example processor device 201 comprising a plurality of functional units 202 and a plurality of instruction control units 214. In some instances, processor device 201 can be configured to transmit (e.g., stream, propagate, etc.) operand data along a data flow axis 218 and transmit instruction data along an instruction flow axis 219. In some instances, the processor device 201 can be configured to perform one or more deterministic data flow operations, such as transmitting (e.g., streaming, etc.) operand data and instruction data at one or more predetermined times defined by a compiler, such that a compiler can control a timing of operand and instruction data flow to cause an instruction and corresponding operand(s) to intersect at a functional unit 202 for executing the instruction at a predetermined time (e.g., clock cycle) selected by the compiler. In some instances, a processor device 201 can be configured to access one or more external memory modules 220 (e.g., near-compute external memory modules 220, etc.), such as one or more external dynamic random access memory (DRAM) modules 221.

In some instances, a processor device 201 can be, comprise, be comprised by, or otherwise share one or more properties with a processor device 101. For example, in some instances, a processor device 201 can have any property described herein with respect to a processor device 101, and vice versa.

In some instances, a functional unit 202 can be, comprise, be comprised by, or otherwise share one or more properties with a functional unit 102. For example, in some instances, a functional unit 202 can have any property described herein with respect to a functional unit 102, and vice versa.

In some instances, a data flow axis 218 can include a direction, axis, or path along which operand data can flow. For example, in some instances, one or more functional units 202 can be configured to receive one or more input operands along the data flow axis; process the input operands to generate one or more output values; and transmit the output values along the data flow axis 218 to another functional unit 202, which can use the output values as input operands, and so on. In some instances, functional units 202 configured to perform related operations (e.g., pairs of operations associated with some machine-learned inference pipelines, etc.) can be located close together along the data flow axis 218; ordered along the data flow axis in an ordering corresponding to an ordering of one or more sets of related operations; or otherwise geographically arranged on a processor die to reduce a cost (e.g., latency, power cost, etc.) or increase a performance (e.g., throughput, etc.) of one or more operations (e.g., machine-learned inference operations, etc.). For example, in some instances, a series of related operations for machine-learned inference can include one or more of: matrix multiplication (e.g., multiplying machine-learned model parameters by input activations, etc.), activation function operations, mixing or combining operations (e.g., attention-based mixing, etc.), preprocessing or postprocessing operations, or other operations. In some instances, an ordering of such operations can include an ordering associated with one or more of: a transformer layer; a fully connected layer; an attention head; a convolutional layer; a pooling layer; a recurrent layer; a gating layer; or other machine learning architecture component. In some instances, a data flow axis 218 can include a physical axis or a logical axis, such as an operand flow path that may include or not include a straight-line operand flow path. In some instances, all or part of a data flow axis 218 can be orthogonal (e.g., logically orthogonal, physically orthogonal, etc.) to an instruction flow axis 219.

In some instances, an instruction flow axis 219 can include a direction, axis, or path along which instruction data can flow. For example, in some instances, an instruction control unit 214 can be configured to provide, to one or more first functional units 202, an instruction; and the first functional unit(s) 202 can be configured to execute the instruction and/or pass the instruction along to neighboring functional units 202 along the instruction flow axis 219. In some instances, a plurality of neighboring functional units along the instruction flow axis 219 can include a plurality of functional units 202 performing similar (e.g., same) functions, such as a plurality of memory functional units 207 or the like. In some instances, a plurality of neighboring functional units along the instruction flow axis 219 can include a plurality of functional units 202 configured to execute the same instruction received from an instruction control unit 214 and propagated along the instruction flow axis. In some instances, an instruction flow axis 219 can include a physical axis or a logical axis, such as an operand flow path that may include or not include a straight-line operand flow path. In some instances, all or part of an instruction flow axis 219 can be orthogonal (e.g., logically orthogonal, physically orthogonal, etc.) to a data flow axis 218.

In some instances, a processor device 201 can include a deterministic processor device 201 comprising a plurality of deterministic functional units 202 configured to perform one or more operations at a predetermined time defined by a compiler at compile time. In some instances, a compiler can control a timing of one or more instruction and data flows to cause one or more instructions traversing the instruction flow axis 219 to intersect one or more operands traversing the data flow axis 218 at a functional unit 202 scheduled to execute the instruction(s) on the operand(s) at a predefined time instant selected by the compiler.

In some instances, a processor device 201 can include a plurality of functional tiles 202, which can include functional units 202 arranged in a tiled arrangement on a processor die. The functional tiles 202 can perform various functions such as vector-matrix multiplication, switching of data along different circuit pathways, and local data storage and retrieval. In some instances, functional tiles 202 can share a common system clock. In some instances, functional tiles 202 can include one or more sets of interconnected functional tiles 202 processing the same data, such as interconnected functional tiles 202 that are adjacent along a data flow axis 218; at a same location along an instruction flow axis 219; or the like. In some instances, a plurality of interconnected functional tiles 202 processing the same data can be referred to herein as a “lane” or “Superlane.” For example, in some instances, each functional tile 202 in a Superlane can be subdivided into 16 sub-tiles, and a set of subtiles processing the same data can be referred to herein as ‘lanes’. A set of data that is processed by one Superlane is referred to herein as a ‘stream’. In some instances, each lane in a tile of a Superlane can be configured to process one byte (e.g., one byte per clock cycle, one byte at a time, etc.).

In some instances, an instruction control unit 214 can be, comprise, be comprised by, or otherwise share one or more properties with an instruction control unit 114. For example, in some instances, an instruction control unit 214 can have any property described herein with respect to an instruction control unit 114, and vice versa.

In some instances, data between two adjacent functional tiles 202 can flow bidirectionally, or can primarily (e.g., most or all of the time) move in one direction along a lane or Superlane. In some instances, a first Superlane can have a direction of flow along the data flow axis 218 that is the same as or different from a direction of flow of a second Superlane. In some instances, operand data can be transferred along the data flow axis 219 at every clock cycle of a processor device 201. In some instances, when processing of operand data is complete in one Superlane, the data can be either returned to a host computer comprising the processor device 201 or transferred (e.g., by permute/routing functional units 111, etc.) to another Superlane for additional processing.

In some instances, a Superlane can process streams of data in 16 lanes. In some instances, each instruction can be performed on all 16 lanes at once, and then, if required by the instructions being executed, in the next Superlane in a subsequent cycle, and so forth. For example, in some instances, if a processor device 201 contains N (e.g., 20, etc.) adjacent Superlanes, then an instruction can be passed to N adjacent functional tiles 201 (e.g., over the course of N clock cycles, etc.), and each instruction can execute on all 16*N (e.g., 320) lanes across the N Superlanes. In some instances, a processor device 201 architecture can include an architecture that lacks register files, and a compiler can schedule the streaming data to be available to the functional tile 202 at a predetermined designated time to execute a designated instruction.

An external memory module 220 can include, for example, a memory device that is external to the processor device 201, such as a memory device on a separate die from the processor device 201 or the like. In some instances, an external memory module 220 can have one or more properties that are the same as or different from one or more properties of a memory functional unit 107. For example, in some instances, an external memory module 220 can include any memory type or device type described herein with respect to a memory functional unit 107. As another example, in some instances, an external memory module 220 can use a first type of memory that is different from a second type of memory used in an on-chip memory functional unit 107. For example, in some instances, a memory functional unit 107 can include a low-latency memory type such as SRAM, and an external memory module 220 can use one or more lower-cost or higher-storage-capacity memory types, such as dynamic random access memory (DRAM). Other memory types are possible without deviating from the scope of the present disclosure (e.g., SRAM or other non-volatile memory (NVM) such as 3D NOR memory, NAND memory, FLASH memory, phase change memory such as 3D Crosspoint memory, a next-generation ferroelectric memory, or a Nanotube RAM, etc.). For example, in some instances, an external memory module can have any property described herein with respect to an external dynamic random access memory (DRAM) module 221, and vice versa.

In some instances, an external dynamic random access memory (DRAM) module 221 can include one or more dynamic random access memory (DRAM) components, such as double data rate synchronous DRAM (DDR) such as DDR5, low-power double data rate synchronous DRAM (LPDDR), synchronous DRAM (SDRAM), low-random-transaction-rate DRAM having a low random transaction rate relative to one or more other memory device types (e.g., SRAM, etc.), or other DRAM component(s).

In some instances, an external memory module 220, 221 can include a deterministic memory device configured to perform one or more operations at a predetermined time defined by a compiler at compile time; a deterministic memory device having a known or constant latency for one or more operation types (e.g., read latency, write latency, etc.); or the like.

In some instances, an external memory module 220, 221 can include a plurality of memory banks, wherein each bank has a plurality of rows for storing data. Each memory bank can be addressable by a processor device 201 for writing data to selected rows in selected banks and for reading data from selected rows in selected banks, wherein data can be read a predetermined time-period before the data is required to arrive at one or more compute element(s) of the processor 201 and data can be written to a memory at a first pre-determined time-period that does not coincide with a memory refresh scheduled to occur at a second predetermined time.

In some instances, an external memory module 220, 221 can include various features to enable high-bandwidth memory access, high levels of memory concurrency, or the like. For example, in some instances, an external memory module 220, 221 can provide deterministic memory access functions (e.g., deterministic-latency operations, etc.) to enable a compiler to control a timing of a plurality of data read, write, or refresh operations; control a level of memory concurrency for accessing a plurality of operands or other data from an external memory module 220, 221; or other memory control functions. As another example, in some instances, an external memory module 220, 221 can include a plurality of concurrently accessible memory banks (e.g., memory banks configured to be active simultaneously, etc.), thereby increasing a memory bandwidth of the external memory module 220, 221. In some instances, an external memory module 220, 221 can be configured to access a full row of memory (e.g., without reference to a column decoder, etc.) at each read or write operation. In some instances, a compiler can provide explicit control of memory location allocations, data path routing, and the like to increase (e.g., maximize or nearly maximize, increase relative to partial-row memory access, etc.) a level of memory concurrency of external memory module 220, 221 operations.

In some instances, an external memory module 220, 221 can include a deterministic memory module having low-random-transaction-rate (low-RTR) memory (e.g., DRAM banks, etc.), and a processor device 201 can provide one or more deterministic operations to reduce (e.g., eliminate, etc.) a need for or usefulness of high-RTR memory. For example, in some instances, a plurality of simultaneously active low-RTR memory banks can be used to provide memory access having one or more performance properties (e.g., bandwidth, latency, etc.) equivalent to high-RTR memory.

In some instances, an external memory module 220, 221 can have one or more features to reduce a power consumption of the external memory module 220, 221 compared to some alternative implementations. For example, in some instances, an external memory module 220, 221 can be placed in close proximity to a processor device 201 to reduce (e.g., minimize or nearly minimize) an amount of power consumed in reading or writing data to the memory module 220, 221 (e.g., due to lower capacitive loading of short signal traces, etc.). In some instances, placing an external memory module 220, 221 in close proximity to a processor device 201 can include connecting the module 220, 221 to the processor device 201 in various manners, such as by face-to-face coupling (e.g., using wafer stacking technology, etc.) or another connection technique (e.g., passive interposer, active interposer, etc.). In some instances, a low-power external memory module 220, 221 can include a memory component (e.g., DRAM component) having sense amps attached directly to row input/output (e.g., without a logic layer or without data buffer(s), etc.).

In some instances, an external memory module 220, 221 can include one or more logic dies and a plurality of memory banks, such as a logic die coupled to a plurality of DRAM banks by through-silicon via and to a processor device 201 in a face to face configuration, etc. In some instances, a logic die can include row buffers for interfacing the processor device 201 to one or more memory components. The memory component(s) can also have an array core and a row decoder. During a read operation, the row decoder can select a row of array cores and the entire row from the selected row can be transferred from the memory component to row buffers on the logic die. In some instances, a memory component or an external memory module 220, 221 can lack column decoders and can read or write an entire row during each R/W cycle. In some instances, a memory plane can include 3D NOR memory.

In some instances, an external memory module 220, 221 can provide a global address space available to a plurality of functional units 202. For example, in some instances, global memory access can be facilitated by one or more permute/routing functional unit(s) 111 of a processor device 201 to allow any processor 201 component at any location on a die to access data residing in any memory bank element of an external memory module 220, 221 or memory functional unit 107.

For example, in some instances, a streaming processor device 201 can provide operand data movement along a data flow axis 218 automatically (e.g., at every clock cycle, etc.), while one or more permute/routing functional unit(s) 111 can provide (e.g., responsive to one or more compiled instructions, etc.) operand data movement along an instruction flow axis 219. Further details of an example permute/routing functional unit 111 providing operand data movement along an instruction flow axis 219 are provided below with respect to FIG. 3.

In some instances, a processor device 201 can have sufficient permute/routing functional unit(s) 111 or data flow operations (e.g., routed data flow, automatic or unrouted data flow, etc.) to enable any retrieved data to be mapped to any functional unit 102 or port thereof. In some instances, permute/routing functional unit(s) 111 can provide additional operations in association with memory retrieval, such as data reshaping, padding (e.g., padding a size of a tensor by adding a plurality of zeros, etc.), duplication, or other data routing operations.

In some instances, a processor device 201 and external memory module 220, 201 can operate deterministically (e.g., with deterministic timing, order of operations, etc.), and can have various features to take advantage of such determinism. For example, in some instances, a deterministic processor device 201 can initiate one or more data retrieval operations a predetermined time period before the retrieved data is required to arrive at one or more corresponding compute elements. This can be used, for example, in combination with slow dense memory that may not necessarily provide low-latency or high-RTR performance of individual read operations, as read operations can be scheduled sufficiently far in advance to enable lower-RTR memory device(s) to perform similarly to a high-RTR memory of some alternative implementations. As another example, in some instances, given a processor device 201 that is deterministic, an external memory module 220 can perform non-destructive row reads, as each row can write new data if aligned with a closing row. This can provide for, for example, improved performance, reduced power usage, or both. In some instances, a deterministic processor device 201 can deterministically write new data or deterministically refresh existing data to the row of the DRAM, thereby enabling higher write bandwidth and better management of a refresh function. In some instances, a refresh function can be performed with new data by accessing a DRAM write register loaded with new data. In some instances, the processor device 201 can also treat the external memory module(s) 220, 221 as a circular read/write access medium having an opportunity to read and write every row location. For example, a row address line of an off-chip deterministic near-compute memory unit 220, 221 can be coupled to a clock. The row address line can be configured to receive a row address from the processor device 201 and increment every clock cycle in accordance with the circular medium access until the row address loops back without explicit addressing. This pattern can provide for even further power reduction and performance improvement while implicitly incorporating refresh support.

In some instances, a processor device 201 can use one or more memory functional unit(s) 107 (e.g., SRAM units, etc.) or another buffer device (e.g., external SRAM units interposed between a processor device 201 and external DRAM module 221, etc.) as a buffer to temporarily store data retrieved from the external memory module(s) 220, 221, or the processor device 201 can be configured to provide retrieved data directly to one or more functional unit(s) 202 for processing or routing (e.g., traversal of a data flow axis 218, etc.).

FIG. 3 is a block diagram of an example system 300 including a language processing unit device 301 according to example implementations of aspects of the present disclosure. The language processing unit (LPU) device 301 can include a plurality of functional slices 302, along with a plurality of data paths 318a, b, c, d, e between the functional slices 302. In some instances, the functional slices 302 can include one or more vector functional slices 310, one or more memory functional slices 307, one or more permute/routing functional slices, and one or more matrix functional slices 309. In some instances, a language processing unit 301 can further include a plurality of communication units 103 (e.g., PCIe unit(s) 313, chip-to-chip communication unit(s) 312, etc.); a plurality of instruction control unit(s) 314; or other component(s).

In some instances, one or more of a processing device 301, functional unit 302, communication unit 303, memory functional unit 307, matrix functional unit 309, vector functional unit 310, permute/routing functional unit 311, chip-to-chip link 312, PCIe 313, or instruction control unit 314 can be, comprise, be comprised by, or otherwise share one or more properties with a component having a similar (e.g., same, etc.) name or part number described herein with respect to another Figure, such as FIG. 1 or 2. For example, in some instances, a processing device 301 can have any property described herein with respect to a processing device 101 or processing device 201, and vice versa; a functional slice 302 can have any property described herein with respect to a functional unit 102 or functional unit 202, and vice versa; and so on.

In some instances, a processor device 301 can include one or more functional regions or sets of functional units 302 with the same functionality executing the same instructions, such as functional tiles 302 located in similar positions in different Superlanes (e.g., at a same point along a data flow axis 218, etc.). In some instances, such a functional region or set of functional units 302 with the same functionality executing the same instructions can be referred to herein as a functional ‘slice.’ In some instances, a processor device 301 can include one or more sets of directly connected slices of the same functional modules, encompassing all the Superlanes, is referred to herein as a ‘partition’.

In some instances, a LPU 301 can include a plurality of slices, wherein each slice in a LPU can perform any of a variety of functions under the control of instructions transferred from buffers in the Instruction Control Unit 314. For example, in some instances, functional slices 302 can include memory functional slices 307 for memory storage and retrieval for data in a Superlane (MEM); functional slices 302 (e.g., matrix or vector functional slices 309, 310, etc.) for integer (INT) arithmetic or floating point (FPU) arithmetic; or permute/routing functional slices 311 for transferring data between Superlanes (NET or SXM). In some embodiments, each of the functional slices 302 can operate independently, and operations of different functional slices 302 can be coordinated using barrier-like synchronization instructions.

For example, the memory functional slices 307 can perform Read and Write operations but not Add or Mul, which can in some instances be performed only in matrix functional slices 309 and vector functional slices 310. In some instances, all of a plurality of tiles in a functional slice 302 can execute the same set of instructions, so it is possible to locate all of the common instruction decode and dispatch logic into the ICU 314, and partition the normal instruction execution pipeline into two sets of instructions: (i) instruction fetch, decode, and parceling and (ii) operand read, execute, and writeback. Functional slices 302 or components thereof can operate without having to receive explicit instructions, or only receiving intermittent or limited instructions, from the ICU when the tiles are dedicated to a specific function, potentially simplifying operation of the processor.

In some instances, a functional slice 302 can include a plurality of functional tiles 202 (e.g., tiles organized along an instruction flow axis 219, etc.). In some instances, functional tiles in the same functional slice 302 (but not necessarily the same Superlane) can execute instructions in a “staggered” fashion where instructions are issued tile-by-tile within the slice over a period of N cycles. For example, the ICU 314 for a given slice may, during a first clock cycle, issue an instruction to a first tile of the slice (e.g., the tile directly connected to the ICU of the slice), which is passed to subsequent tiles of the slice along an instruction flow axis 219 over subsequent cycles.

In some instances, a processor device 301 can include a first and second matrix functional slice 309 or first and second set of matrix functional slices 309; a first and second permute/routing slice 311 or first and second set of permute/routing slices 311; a first and second memory slice or first and second set of memory slices 307; and a first vector functional slice 310. For example, in some instances, each Superlane can include a first set and second set of matrix multiplication tiles (M×M1 and M×M2), a first and second set of data path switching tiles (SXM1 and SXM2), a first and second set of memory tiles (MEM1 and MEM2), and a first set of vector calculation tiles (V×M1), wherein just one tile in M×M1 transfers data with one tile in SXM1, wherein just one tile in SXM1 transfers said data with just one tile in MEM1, wherein just one tile in MEM1 transfers said data with just one tile in V×M1, wherein just one tile in V×M1 transfers said data with just one tile in MEM2, wherein just one tile in MEM2 transfers said data with just one tile in SXM2, and wherein just one tile in SXM2 transfers said data with just one tile in M×M2.

In the above example, data transfers are entirely in one direction, for example M×M1 to SXM1 to MEM1 to V×M1 to MEM2 to SXM2 to M×M2. However, in other examples, data transfers can occur in multiple (e.g., two, etc.) directions, for example, one set of data transfers from V×M1 to MEM1 to SXM1 to M×M1, and another set of data transfers from V×M1 to MEM2 to SXM2 to M×M2.

In some instances, each Superlane, and in some instances the entire LPU 301, can execute a single set of instructions, such that the LPU 301 may be considered as a single processor core. However, in some instances, the LPU 301 Superlanes can be partitioned into two sets of functional modules. For example, in a split architecture with only one central vector functional slice 310, a central vector multiplication tile that contains 16 ALUs can allocate the ALUs to either set. In other instances, additional vector functional slices 310 may be allocated to a set. The additional vector functional slices 310 may be physically or logically located, for example, next to one of the matrix functional slices 309.

For at least one embodiment, FIG. 3 can depict the silicon layout of a LPU 301 with multiple Superlanes, as well as processor chip to processor chip (C2C) interface modules 312 and the ICUs 314. In this example embodiment, there are 20 Superlanes forming the majority of the floorplan of the laid-out silicon circuitry. Surrounding the Superlane partitions is circuitry for the ICUs, modules for processor-to-processor communication, and modules for host-to-processor communication. In one embodiment, the host-to-processor modules comprises a PCIe (Peripheral Component Interconnect Express) circuit 313. In some instances, a host-to-processor communication module can bidirectionally transfer data from the host computer through a permute/routing functional slice 311 to and from a memory functional slice 307. In some embodiments, a processor-to-processor communication C2C module 312 directly transfers data to a permute/routing functional slice 311.

One example implementation of a LPU 301 chip contains 26.8 billion transistors on a 725 mm² die built in 14 nm ASIC technology, and is designed using standard EDA tools from circuit design through tape-out before fabrication. The die area splits about evenly between memory and compute units (not counting I/O). Instruction control requires only 3% of the die area. One Superlane in the example LPU 301 can be initially unused, so it can be connected to the rest of the architecture to replace any Superlane that is defective; this redundant feature adds only about 4% to the die area. In this embodiment, each memory partition can have 44 memory functional slices 307 each comprising 20 memory functional tiles 202.

In some instances, a LPU 301 can include a large on-chip Static Random Access Memory (SRAM), which can in some instances reduce or eliminate a need for external memory. For this reason, a LPU 301 may not need to include DRAM controllers and interfaces. However, a processor device 101, 201, 301 can include a processor device configured to interact with external memory (e.g., external DRAM, etc.) without deviating from the scope of the present disclosure. Some example LPU 301 chips can include an x16 PCI Express (PCIe) Gen4 interface to connect to a host processor (e.g., central processing unit of a host computing device, etc.). In some instances, compilers that execute on the host computer or another device can download the machine learning algorithm instructions and data to the LPU 301, typically from the host computer through the PCIe interface 313 through permute/routing functional units 111 (e.g., tiles, etc.) adjacent to the PCIe interface 313 into the memory functional slices 307 (e.g., MEM partitions comprising one or more memory functional slices 307, etc.). The LPU 301 can then autonomously execute the model by transferring the instructions and data in the MEM partitions into one or more functional slices 302. After processing, in some instances, results can be transferred from one or more functional slices 302 (e.g., vector functional slice(s) 310, etc.) back to the host computer (e.g., via one or more permute/routing slices 311 and via one or more PCIe devices 313.

### Streams

Machine learning algorithms can in some instances operate on vectors with scalar coefficients of a specified data type (e.g., INT8, FP16, etc.). In some instances, Superlanes of a LPU 301 can operate on data representing vectors, sometimes organized into rank-2 tensors. In some instances, a LPU 301 can operate on higher-rank tensors by using a compiler to transform higher rank tensors into rank-2 tensors. In some instances, a LPU 301 can implement a programming model that is a producer-consumer model where each slice in a partition acts as a consumer and a producer of one or more streams.

In some instances, a LPU 301 architecture can support a plurality of streams (e.g., 32 streams, etc.) in each set of tiles in two directions. In some instances, a number of streams can be dependent on the availability of wiring of the inputs and outputs for the stream registers. In some instances, each stream can automatically progress in a designated direction (e.g., designated direction along a data flow axis 218 or data path 318, etc.) on every cycle (e.g., moving 32 bytes each cycle via 32 streams, etc.). In some instances, inter-lane data movement (e.g., data operand movement in a direction other than the data flow axis 218, etc.) within a vector can be performed using a permute/routing functional slice 311.

When a set of data representing a vector is read from main memory, it can be given a stream identifier (0 . . . 31) and direction of flow in a Superlane. Once a vector is read into one or more stream registers in a lane, it can become a stream and flow towards a functional slice 302 that is scheduled to process the vector, and the functional slice 302 can process the vector to produce a result stream. As data in a stream flows through a slice, each functional module can intercept the data and perform a calculation (if the module is calculational), or move data between lanes (e.g., in permute/routing functional slice(s) 311).

The stream registers can be used to transfer operands and results between slices. An example software pattern can include reading operand data from one or more memory functional slices 307 that is then subsequently consumed and operated on by a downstream arithmetic slice (e.g., matrix functional slice 309, vector functional slice 310, etc.). The results of the operation can then be transferred to another stream such that they can be written back to memory. For example, a Z=X+Y operation might be performed by executing four instructions: Read S1,X and Read S2, Y are executed on two memory functional slices 307 and directed toward a vector functional slice 310 to perform the Add S1,S2,S3. Then the result can be stored back to a memory functional slice 307 via a Write S3,Z.

An instruction can operate on data from different streams. For example, ADD S1, S2, S3 adds each value in stream 1 to the corresponding value in stream 2 and stores the results in stream 3.

In some instances, a functional slice 302 can include a functional unit 102 configured to perform a given operation (e.g., operation associated with a single instruction received from an instruction control unit 314, etc.) for a plurality of repetitions on operands streamed over a plurality of clock cycles. For example, in some instances, a functional slice 302 or component thereof (e.g., functional tile, etc.) can be configured to receive an instruction comprising repetition data indicative of a number of times to repeat a given operation; a number of clock cycles to delay between repetitions of the given operation; or other repetition data. Based on the instruction, the functional slice 302 can perform, at each of a plurality of clock cycles, the given operation on one or more operands arriving in one or more streams (e.g., Superlanes, etc.) at each of the plurality of clock cycles.

A lane structure configured to hold one byte per lane can be well suited for INT8 data, but larger operands (INT16, INT32, FP16, or FP32) can also be formed by combining streams. This approach can provide for a compiler to operate, for example, on 320-element vectors for all data types. Wider data types can be assigned to adjacent streams along aligned boundaries. For increased reliability, a Superlane can apply a 9-bit error-correction code (ECC) across all 16 lanes, correcting nearly all errors. A LPU 301 can log these errors and report them to a host computer. In one embodiment, the ECC protocol is SECDED (single-error correction with double error detection). Before a functional slice operates on a stream of data, it can check the ECC bits to ensure data integrity before operating on the data.

In some instances, each element of a stream can be 1-byte, with larger data types (e.g. INT16, INT32, and FP32) constructed from several streams (2, 4, and 4 respectively). Multi-byte data types can be handled such that they are always stream-aligned based on the size of the data type. For instance, INT16 can be aligned on a stream pair, bi-stream, and INT32 can be aligned on a quad-stream (e.g., one set of four adjacent data paths 318 per INT32 value, etc.). Data alignment can be accomplished by the compiler or through an application programming interface (API).

In some instances, each stream can have one or more “valid/empty” bits precisely tracking the stream's load-to-use time beyond which the stream is considered logically dead and no longer propagated, which can achieve a reduction in power consumption of the LPU 301.

### The Instruction Control Unit

Some instructions in the ICUs 314 can be common to all functional slices 302. As such, the instructions can contain common instructions like NOP and Repeat, and synchronization instructions Sync and Notify to allow the functional slices 302 to be initially synchronized, so a compiler can accurately determine instruction execution times and allow cooperative parallelism among the functional slices. ICUs 314 can retrieve pages of instructions in the MEM partitions, sending Ifetch instructions across side channels in the memory slices, and receiving the instructions from memory back along the same side channel.

The ICUs 314 can provide explicit instruction fetching for the slices with the Ifetch instruction, and inter-slice synchronization using the Sync and Notify instructions to perform a chip-wide barrier synchronization among participating functional slices. A repeated-NOP (no-op) instruction can allow for precise cycle-by-cycle control of inter-instruction delay. For example, a compiler can have cycle-accurate control when scheduling two operations A and B using an intervening NOP so that N clock cycles separate the operations A and B, i.e., Operation A then NOP (N) then Operation B.

A compiler can use explicit NOPs to provide temporal separation between two instructions in the program order. A NOP can have a repeat count 16-bit field which allows one NOP to wait between 1 ns and 65 us for a 1 GHz clock frequency. A compiler can use NOP instructions to control relative timing of the functional slices 302 and data on which the functional slices operate. A repeated NOP can be implemented in the ICU 314 and can be common to all functional slices 302. While a NOP instruction can be the most common instruction, the NOP instruction may not be included in the specification for a machine learning model, but rather may be inserted into the instructions generated from the model by a compiler.

In some instances, a vector functional slice 310 can include a central vector functional slice 310 containing 16 Arithmetic Logic Units (ALU) per lane. Each ALU can perform, for example, a 32-bit calculation using aligned groups of four stream bytes as operands. In addition to the usual arithmetic and logical operations of some conventional ALUs, ALUs of a vector functional slice 310 can be configured to convert between integer and floating-point formats. In some instances, a vector functional slice 310 can be configured to perform some predefined normalization functions such as ReLU and the hyperbolic tangent (tanh) as well as exponentiation and reciprocal square roots, allowing programmers to build their own normalization functions.

In some instances, a language processing unit device 301 can be organized into a plurality of Superlanes, and a vector functional slice 310 can implement, for each Superlane, a 4×4 mesh of vector ALUs using the 16 vector ALUs per lane. In some instances, an ALU can be configured to receive 32-bit input operands, wherein each of an ALU's 32-bit input operands are organized along an aligned quad-stream group.

In some instances, a vector functional slice 310 ALUs can include stateless ALUs, such as ALUs that do not produce condition codes or status flags from the last instruction. For example, in some instances, instead of condition codes or status flags, a vector functional slice 310 can provide both saturating and modulo variants (add_sat, add_mod and mul_sat, mul_mod) for addition and multiplication, which can allow differing semantics for handling arithmetic exceptions. In some instances, a language processing unit 301 can support chaining together two or more vector ALUs within each lane, allowing multiple ALU operations to be performed without transferring the intermediate results to main memory, saving a write and subsequent read of each intermediate result. This can in some instances allow for efficient parallel implementations of algorithms for batch normalization, quantization, or more complex activation functions like the leaky ReLU activation function, for example.

In some instances, a matrix functional slice 309 partition can include a plurality of independent regions (e.g., grids, etc.) of multiply-accumulate modules, such as four independent 320-by-320 grids of multiply-accumulate (MACC) modules. In some instances, each 320 by 320 grid can include 20 16 by 16 sub-grids that each produce a partial-sum/dot product result each cycle and pass the result to an adjacent functional tile 202 for use in its computations. In some instances, an N by N grid can use N streams each with N bytes to install N² parameters (e.g., 8-bit weights (IW), etc.) in each grid on every cycle. Using all 32 streams in each direction can allow weights to be placed simultaneously in multiple matrix functional slice 309 partitions, loading 409,600 weights (e.g., all weights of some example machine-learned models or model partitions, etc.) on-chip in less than 40 cycles. With weights installed, every cycle the matrix functional slice(s) {M}09 can generate a new dot-product (e.g., INT32 dot product, etc.) of input activations with installed weights. The features output from the matrix functional slice(s) 309 can be accumulated using accumulators on each INT32 or FP32 output stream.

In some instances, a matrix functional slice 309 can support calculations for multiple numerical formats by combining results from multiple lanes. For example, in some instances, a matrix functional slice 309 can support both 8-bit integer (INT8), and 16-bit floating point (FP16), by using two 320×320 byte-planes in tandem for the 16-bit floating point results. In some instances, a 320-element sum can be produced for each output with only a single rounding step at the end to convert to INT32 or FP32 results. Matrix functional slice 309 processing can include, for example, one or more of the following operations (instructions): LW—load weights from data flows (streams) to weight buffer; IW-install weights from data flows (streams) or LW buffer into the 320×320 array; ABC-activation buffer control to initiate and coordinate arriving activations; ACC-accumulate either INT32 or FP32 result from M×M.

In some instances, each MACC unit can have two 8-bit weight registers and two 32-bit accumulators. On each cycle, each MACC unit can multiply the stored weight values by a pair of activation values from the streaming data. In some instances, each 16×16 sub-grid can compute an integer partial sum in one cycle and a complete 320-element fused dot-product in 20 cycles. In some instances, a MACC unit can instead operate as a single FP16 MACC, but these operations can require two cycles, reducing throughput by 75% relative to INT8 operations. In some instances, each matrix functional slice 309 partition can have 320×320 MACC units producing 409,600 INT8 operations or 102,400 FP16 operations per cycle. Using all 32 streams in each direction, the LPU can load all 409,600 weight registers in less than 40 cycles.

The permute/routing functional slice(s) 311 (sometimes referred to herein as switch units, ‘SXM’ or ‘NET’) can execute functions for the transposition, permutation, shifting and rotation of data elements. Collectively, these operations can be used for performing tensor reshape operations, such as tensor reshape operations associated with one or more machine learning operations. For example, in some instances, a permute/routing functional slice 311 can rotate or transpose a stream of data across the lanes. In some instances, a permute/routing functional slice 311 can duplicate bytes to fill a vector or zero any of the vector elements to pad values. In some instances, permute/routing functional slice 311 can be the only tiles of a processor device 311 that communicate between Superlanes. Further details of some example permute/routing functional slices 311 are disclosed in U.S. Pat. No. 10,754,621, incorporated herein by reference.

Data movement on-chip can be carried out by routing data along one or more pathways, such as pathway(s) where data is transferred between SRAM and functional modules within each Superlane, and pathway(s) where the permute/routing functional slice 311 transfers data across lanes using two sets of lane shifters. The lane-shifters can in some instances be allocated in pairs to facilitate shifting a vector between a lane and its two adjacent lanes in a Superlane. Additionally, in some instances, the permute/routing functional slice 311 can provide a permute instruction that uses a programmed bijection to remap a plurality of lanes (e.g., 320 lanes, etc.) onto a set of similarly indexed streams, one per Superlane.

In some instances, permute/routing functional slice 311 can include one or more distributor slices. For example, a distributor slice within a permute/routing functional slice 311 can be used to arbitrarily remap a plurality of (e.g., 16) lanes within each Superlane. As streams pass through the SXM's distributor, they can be remapped at full bandwidth, or zero-fill any or all of the 16 elements. This can provide an efficient mechanism for common tensor operations like zero padding or rearranging elements of a convolutional neural network filter (e.g., 4×4 filter, etc.).

An example operation on tensor data types can include transposition. In some instances, a LPU 301 can support a two-dimensional transpose of 256 elements organized as 16 streams each with 16 elements. A transpose operation can take 16 incoming streams and produce 16 output streams with the rows and columns exchanged. This allows the efficient movement of data from the atomic 16-byte MEM word into 16 different MEM slices where they are now addressable. In some instances, a LPU 301 can include two instances of the SXM on-chip, one in each hemisphere. Each can issue, for example, two (2) transpose instructions, yielding a maximum of four (4) simultaneous transpose 16×16 operations.

In some instances, a tensor streaming processing device 301 can have a plurality of memory partitions (e.g., two partitions, etc.) each having 44 memory functional slices 307 comprising ECC-protected SRAM, with each slice comprising 20 tiles that provide a total capacity of 2.5 MiBytes (wherein a Mibyte is 1048576 bytes) per slice, giving the two MEM partitions a total capacity of 220 MiBytes. Each memory functional slice 307 can include, for example, at least two sets of memory cells referred to as ‘banks’. Each MEM slice can include pseudo-dual-port SRAMs that can service a pair of read and write requests simultaneously, assuming they are not targeting the same bank. In such instances, the 88 memory functional slices 307, each with 2 banks, can enable up to 176-way memory concurrency to read operands to or store results from streams. Banks of memory not being used can have their power reduced to reduce energy usage.

In some instances, the memory functional slices 307 can be configured to provide sufficient memory concurrency to supply a target number (e.g., 32, etc.) of operands per lane, every cycle. For example, in some instances 88 slices having 176-way memory concurrency can provide sufficient concurrency to supply 32 operands per lane each cycle. In some instances, memory functional slices 307 can be partitioned into 16-word bytes, each word distributed across a Superlane, and each byte of each word processed by one lane of the Superlane. In some instances, a memory functional slice 307 can perform two 16-byte reads and two 16-byte writes per cycle, as long as they access different banks, allowing it to both source and sink data in two directions across all lanes in a Superlane.

In some instances, on-chip memory can supply operands for each functional slice 302 by reading an address from a memory (MEM) functional slice 307, denoted MEMᵢ. In some embodiments, slices in each memory can be numbered 0 to 43, with MEM₀ closest to the vector functional slice 309 and MEM43 nearest to the permute/routing functional slice 311.

In some instances, memory partitions can enable the programming abstraction of a partitioned global shared address space with the address space laid out uniformly across the slices. In some instances, each memory functional slice 307 can support both direct and stream-indirect addressing modes. Read and Write operations can use direct addressing, since the address is fully specified in the instruction itself. Indirect addressing can use the contents of a stream, s, to specify an address map for a Gather or Scatter. With indirect addressing, the physical address can be transmitted within the stream value, providing a layer of indirection in the memory referencing.

In some instances, each memory functional slice 307 can have two dedicated dispatch paths, one for each port of the pseudo-dual-ported SRAM. Each memory instruction can undergo an additional address generation stage for strided references by computing the address ai from the previous address aᵢ₋₁ and strides so that aᵢ=aᵢ₋₁+s between locations. Strided memory references can be accomplished using a sequence of countdown, step, and iters MEM instructions. For example, the following example assembly-language snippet, explicitly schedules read and write instructions at program time t=10 to iterate starting at address 0x1000, striding by 24 on each iteration, for 112 total vectors, as shown in the example below for MEM West slice 43.
.MEM West 43
.read
10: read 0x1000, S_0_e
   step 24
   iters 111
.write
10: write 0x00ff, s_16_w
   step 1
   iters 111

This iteration mechanism in the address generation circuitry can support for example, multiple levels (e.g., up to four-levels, etc.) of nested iteration allowing for multi-dimensional arrays to efficiently encode tensors as a short sequence of read or write, or gather or scatter, operations followed by countdown, step, and iter instructions to control the loop bounds. The countdown instruction can specify an inter-loop delay in cycles.

As a non-limiting illustrative example, consider a LPU 301 having a 1 GHZ operating frequency of the LPU 301 clock. The stream register bandwidth, B, exported by each MEM interface on the East and West edge of each MEM partition can keep the functional modules adequately fed with data operands in order to saturate the peak arithmetic capacity of the functional modules. The stream registers can provide a combined capacity of 20 TiB/s of read (operand) and write (result) bandwidth (a Tib is a Mibyte of Mibytes).

To maximize stream concurrency, a compiler can allocate memory for concurrent stream operands associated with a single tensor into separate memory functional slices 307. For example, as the streams propagate through the MEM system they can “pick up” the arguments from a plurality of separate memory functional slices 307 enroute to one or more other functional slices 302 (e.g., matrix functional slices 309, etc.). In some instances, a compiler can explicitly schedule individual banks of each MEM slice to achieve fine-grain memory management. This can enable design patterns and use-cases where simultaneous reading of operands from one bank and writing of results to the other bank in the same memory functional slice 307. As an example, a transpose instruction can take 16 input streams and produce 16 output streams with the rows and columns transposed. By using the bank concurrency available within each memory functional slice 307, it is possible to use the pseudodual-ported SRAM for dual read/write accesses per memory functional slice 307.

In some instances, a LPU 301 can include a memory system that is unlike a memory system of a conventional central processing unit (CPU). For example, some conventional CPUs may rely on a memory hierarchy to implicitly move data between caches to service load/store operations. Cache hierarchies can introduce a reactive agent in the data path and can introduce undesired unpredictability, or non-determinism, in the data path to provide the illusion of sequentially consistent memory transactions within the memory hierarchy.

In some instances, a LPU 301 can differ from a conventional CPU memory by providing a memory management layer that identifies the memory concurrency on an operation by operation basis. As an example, the Python code below shows memory management for an example transpose operation; an instruction that takes 16 streams as input and creates 16 streams of output. The g.malloc function returns a tensor of addresses allocated across 16 memory slices, one for each concurrent stream:

```
# Read from 16 slices onto 16 slices
# Transpose data
# Write from 16 slices into 16 slices
Import groq as g
tensor = g.random_tensor(shape=[1024, 320],
  dtype=g.Int8, layout=[64, 16])
streams_16 = tensor.read(streams=range(16))
streams_16_t = g.transpose16(streams_16)
out_addres = g.malloc(shape=[1024, 320],
    layout=[64, 16])
streams_16_t.write(out_addrs)
```

In some instances, the memory functional slices 307 can store very long instruction word (VLIW)-like instructions, such as instructions that are 2,304 (144×16) bytes wide. In some instances, a program can fetch instructions when the memory functional slices 307 are otherwise idle. For example, in some implementations, instruction fetches can require less than 10% of the total memory bandwidth of the memory functional slices 307. Instructions can be decoded and loaded into queues, allowing the program to prefetch. To reduce code size, a REPEAT N instruction can repeat a previous instruction N times. In some instances, a program can specify a NOP instruction to last for N cycles.

Each functional slice 302 can have a predefined set of instructions (e.g., Read, Write, Add, Mul, etc.) that define its supported operations. Furthermore, functional slices 302 can consume operands from, and produce results to, streams. A more complex sequence of operations, a microprogram, can be composed of one or more slices 302 coordinating in a producer-consumer manner to create one or more output streams. This can be accomplished by logically chaining multiple slices 302 together to consume input data from up-stream slices 302, operate on that data to produce a new result stream, where it later can be consumed by a down-stream slice 302 in a similar manner. In some instances, each functional slice 302 can choose a direction of its result stream. With this cooperative producer-consumer model operating on data streams, more elaborate operations can chain together different functional slices 302, for example, where a composite function, F(x, y, z)=MEM(x)→SXM(y)→M×M(z), is an amalgam of several functional slices 302 chained together.

This dataflow composition exploits ‘data flow locality’ by passing the same data across multiple functional slices 302 which can operate on the data to produce some output stream. The output from one functional slice 302 can be transferred to the input of another slice 302 allowing for chaining of operations through a common stream register.

In some instances, the underlying data type supported by a LPU 301 can be a vector. For example, in some instances, a number of elements in each vector can vary from 16 elements, one Superlane, all the way to 320 elements using all 20 Superlanes on-chip. That is, the minimum vector length, or minVL, can be 16 bytes and the maximum vector length, or max VL can be a 320 byte-sized element array. Because the vector length can vary from 16 to 320 elements, instructions can configure each tile for a low-power mode to effectively power down any unused Superlane (row of the mesh) and reduce the power consumed. This scalable vector approach allows the vector length to grow from 16 to 320 bytes in 16-lane steps, powering-down the unused tiles, yielding a more energy-proportional system.

In some instances, an instruction set architecture of a LPU 301 can provide temporal information about each instruction to allow a compiler precise control of each instruction's dispatch time. For example, in some instances, each instruction can be augmented with one or more of the following temporal parameters:

dfunc functional delay—each instruction requires 1 or more cycles to produce its stream output. A functional delay timing parameter can allow the compiler to reason about when the output of an instruction will be available on the architecturally-visible stream registers.

dskew instruction-operand skew—the timing relationship between the instruction dispatch time relative to when its stream operands are required. An instruction-operand skew parameter on each instruction can inform a compiler how to schedule the operand arrival times with the instruction dispatch time in order to get them to properly intersect in time and space.

Such parameters can be useful to track the exact spatial relationship between instructions and operands.

In some instances, a programming model for a LPU 301 can include, for example, the following two elements: (1) scheduling specific data paths in hardware, and (2) exposing temporal information about an instruction's execution latency through the Instruction Set Architecture (ISA), so that the compiler's back-end can precisely track the position and time-of-use of any stream on-chip.

A compiler can use NOP instructions to control the relative timing of the functional slices 302 and the data on which they operate. A NOP can have, for example, a repeat count 16-bit field which allows one NOP to wait from Ins up to 65 us for a 1 GHz clock. The NOP instruction can be implemented in the ICU's tile and can be common to all functional slices. The NOP can allow the slice to turn off the clock when performing no operations for anything longer than a few cycles (i.e., n>4 cycles).

Each functional slice 302 can be independent; however, the compiler can keep track of a logical program time. Conceptually this can be similar to a program counter in a conventional CPU, except the compiler can track the state of a plurality of (e.g., 144, etc.) independent program queues on a cycle-by-cycle basis. So, at logical time t the compiler can know the state of each Instruction Queue (IQ) inside each Instruction Control Unit. NOP instructions coordinate the temporal relationship between instructions in the same IQ, or between instructions in different IQs. In addition to repeated-NOPs, a higher-level synchronization across all functional slices 302 on a chip can be enabled in order to reason about program correctness. For example, in some instances, Sync and Notify instructions can provide a barrier synchronization mechanism across all independent queues on the LPU 301. One IQ can be designated as a notifier configured to issue a Notify instruction while all other IQs can be parked on a Sync instruction. The receipt of a Notify can be broadcast to all the IQs to satisfy the pending Sync and begin processing instructions again.

This barrier synchronization can be performed, for example, only once after the LPU 301 resets. However, in practice, some programs may start with a set of “preamble” instructions which configure each tile. After that a Sync instruction can be performed to ensure that all functional slices are aligned to the same logical time. In some example embodiments, a chip-wide barrier synchronization can be accomplished in 35 clock cycles, from the time a Notify is issued to the time a Sync is satisfied and retired to allow subsequent instructions to flow. After this barrier synchronization, the functional slices 302 can compute and communicate results in a synchronization-free manner through the stream registers.

Repeat (n, d) is an ICU instruction issued to repeat a previous instruction n times, with d cycles between each iteration. Allowing variable amounts of delay between iterations can allow a compiler to temporally align the repeated instruction with its operands in-flight. This simple but flexible iteration mechanism can allow vector functional slices 310 and matrix functional slices 309, which are often highly iterative, to encode their instructions more efficiently by making better use of main memory and reducing the number of Ifetch instructions compared to if the loop were unrolled.

An Ifetch instruction can have a single stream operand which carries the instructions in their program order, filling an instruction queue with, for example, 640-bytes (e.g., a pair of 320-byte vectors) of instructions. In some instances, all functional slices 302 can fetch instructions simultaneously with normal instruction execution. In some instances, a compiler can perform omniscient prefetching of the program's instructions to keep all 144 IQs busy on each cycle by inserting Ifetch instructions into every slices' instruction stream. In some instances, a LPU 301 or compiler can include a mechanism to ensure that IQs never are empty so that a precise notion of ‘logical time’ is maintained across the processor.

In some instances, a LPU 301 can be configured to transmit data along a stream without packet routing, arbitration, or the like. For example, on each tick of the core clock, the LPU 301 can propagate stream values by one stream register hop. The LPU 301 hardware can, for example, propagate stream values without tracking the origin or destination slice, such as by allowing streams to simply propagate until they fall off the edge of the chip or are overwritten by a functional slice 302. In some instances, a LPU 301 can use stream registers within each memory functional slice 307 to move data along a Superlane, and can use one or more permute/routing functional slices 311 to move data between Superlanes. An instruction can specify one or more source streams-direction pairs, and a target stream and output direction for the result, effectively providing direction routing of the stream data.

In some instances, a network of LPU 301 processors can be connected via Chip-to-Chip (C2C) modules 312. The processors 301 can logically behave as if all chips share a common clock and are connected via time multiplexed wires. LPU 301 chips connected via C2C 312 do not need to share a clock; reasonable alignment of the frequency of the clocks (measured in PPM) can suffice. In some instances, receive buffers in the communications modules can be large enough so that the expected PPMs of clocks don't require a realignment more than once per millisecond, or otherwise don't require realignment often enough to cause difficulty in scheduling between model executions.

In some instances, C2C modules 312 can either provide sufficient Forward Error Correction for data transfer between chips such that unrecoverable errors will occur <1 per week per chip when using all C2C links, or provide software with a mechanism to add additional redundancy so that errors will occur <1 per week per chip when using all C2C links 312. If error rates are lower at a lower transfer rate (e.g. 16 Gb/s), then SerDes can be configured to run at a lower rate for improved precision.

Transfers of data between LPU chips 301 during a compute phase of a program can be supported, e.g. while COMPUTE[i].CHIP[A] is running on chip A, it may send data to COMPUTE[i].CHIP[B] on chip B, which may result in data being returned to COMPUTE[i].CHIP[B] and used before the computation completes. This can differ, for example, from some from PCIe 313 implementations, which may only allow data to be transferred before and after a COMPUTE phase.

In some instances, each C2C 312 SerDes of a LPU 301 can be an independent link, e.g., each link may be the only connection to another device or may be one of multiple connections to another device. Multi-chip systems can be implemented in a variety of topologies for flexible packaging and deployment in rack-scale and cluster scale systems. Communication can occur in a pair-wise manner between a sender port and a receiver port. A sender can perform a MEM read to read an address a onto a stream heading toward a permute/routing functional slice 311. The permute/routing functional slice 311 can perform a Send on the C2C unit 312 representing the physical port where the data is transmitted. On the other side of the link, after a fixed delay for time-of-flight on the wire, the LPU 301 performing the Receive instruction can pull, for example, a 320-byte vector off the channel for every Receive issued.

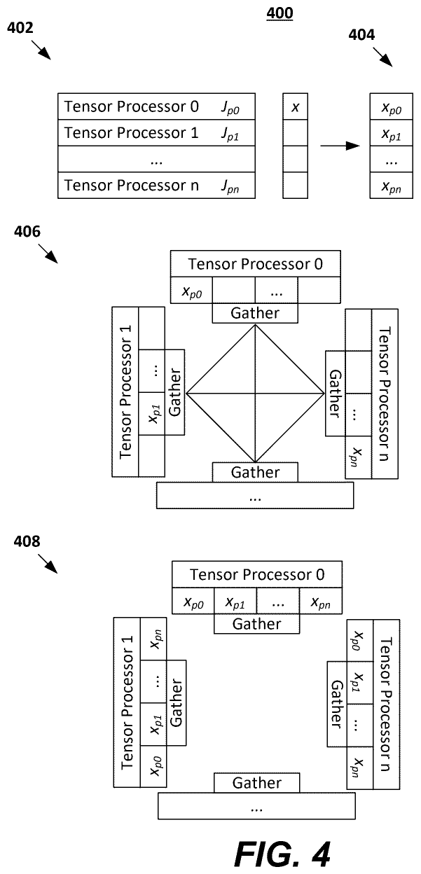

FIG. 4 illustrates a diagram of a process 400 for solving QUBO Hamiltonian equations using a tensor processor according to example aspects of the present disclosure. The solution illustrated in FIG. 4 describes a distribution of a coupling matrix J and a vector x for a computing system including a plurality of tensor processors (e.g., LPUs) arranged with internode chip-to-chip communication capability. For instance, each LPU can be configured with one or more internal connectors, providing for bidirectional communication lanes between each LPU (e.g., forming an “all-to-all” communication topology.

As illustrated at operation 402 of FIG. 4, the coupling matrix J can be decomposed, and data from a host can be distributed to a plurality of tensor processors in the topology, represented as Jₚᵢ, where i={0, 1, . . . n}. In some implementations, n may be the size of the C2C topology and/or may be a power of two. Each tensor processor (e.g., LPU) can perform respective computations, resulting in partial outputs xₚᵢ of the vector x at operation 404. Next, as illustrated in operation 406, the tensor processors can communicate using a gather-all approach to reduce the output. In some implementations, memory allocation can be performed during this C2C data exchange. Finally, as illustrated in operation 408, the vector x can be assembled from the results of each tensor processor.

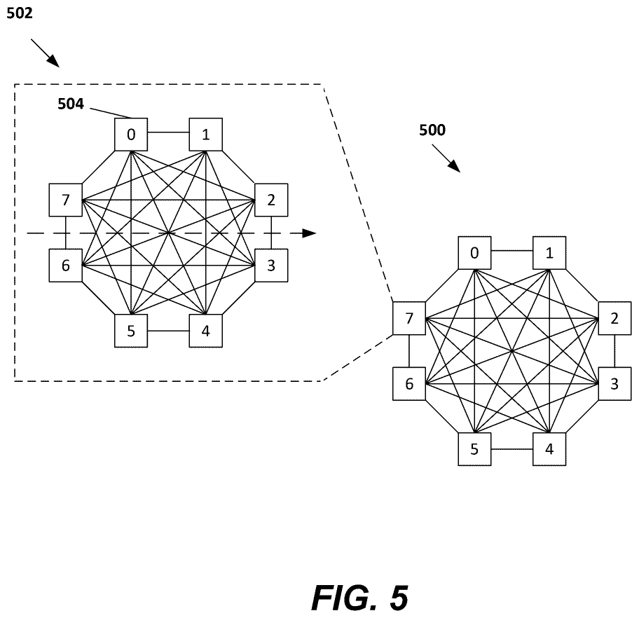

FIG. 5 illustrates a system 500 including a plurality of nodes 502 configured according to a multi-node configuration according to example aspects of the present disclosure. In particular, the system 500 depicts a combination of intra-node and inter-node C2C communication. The system 500 depicts one example configuration according to example aspects of the present disclosure, where eight processors 504 are arranged into a node 502. Communications between these processors 504 in a common node 502 can be referred to as “intra-node communications.” In addition, eight nodes 502 are arranged into the system 500. Communications between processors 504 of two or more nodes 502 can be referred to as “inter-node communications.” It should be understood that more or fewer processors 504 can be included in a node 502, and/or more or fewer nodes 502 can be included in a system 500 without departing from the present disclosure. For instance, in some implementations, a number of nodes 502 in a system can be equal to a number of processors 504 in a node 502.

The system 500 can facilitate complete data exchange between tensor processors (e.g., “chips”) 504 with a maximum of three “hops” (e.g., transmissions between devices). For instance, data such as the partial vector x values can be transmitted from any originating processor 504 in the system 500 to any receiving processor 504 in the system 500 with no more than two intermediate transmissions. In one example implementation of this three-hop communication, the first (e.g., intra-node) hop can implement local C2C exchange of partial vector x values using a broadcast-all approach. The second (e.g., inter-node) hop can broadcast local partial results from each node 502 to all other nodes 502 in the topology. The third hop can be used to synchronize all partial results in the global vector x by executing an additional intra-node gather operation (e.g., as depicted in FIG. 4).

The three-hop communication approach described with respect to FIG. 5 can present a number of benefits. First, the three-hop solution can reduce a number of hops required for data exchange (e.g., compared to a ring topology). The reduction in the number of hops required for data exchange can facilitate data exchange more quickly and/or efficiency, providing improved latency and performance. For instance, each hop can consume some amount of computing resources, such as electrical power, processing resources, network bandwidth, time, and/or other resources, such that a reduction in the number of hops can provide for the conservation of these resources. Additionally and/or alternatively, the three-hop solution described above can provide for improved scalability over some existing approaches (e.g., the ring topology). For example, by using a broadcast-all approach for local C2C exchange of partial vectors, the three-hop solution can provide for more efficient communication between nodes. This can, in turn, provide for an increased number of nodes in the topology without significantly impacting performance. Additionally and/or alternatively, the three-hop solution described above can provide improved reliability over some existing approaches (e.g., the ring topology). For instance, by providing multiple paths for data exchange, the three-hop solution can provide that communication may be maintained even if a node fails or a link is taken offline. This can provide for improved fault tolerance and/or increased system availability. Additionally and/or alternatively, the three-hop solution described above can provide improved load balancing over some existing approaches (e.g., the ring topology). For instance, by distributing the communication load more evenly across nodes, the present disclosure can provide that no single node may be overwhelmed by network traffic, in turn providing improved system performance and/or stability.

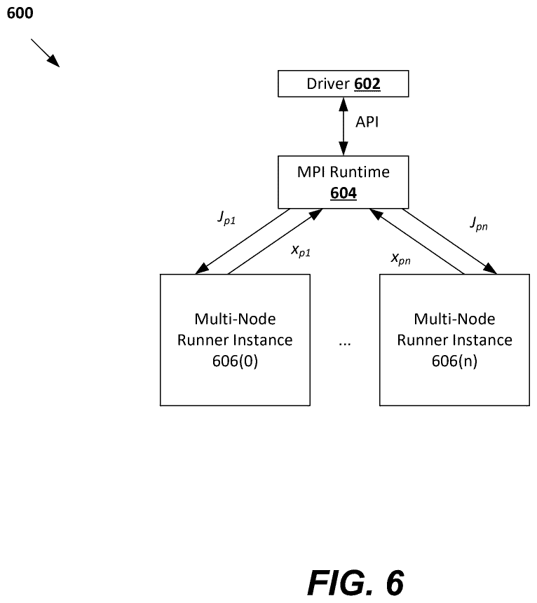

FIG. 6 illustrates a system 600 according to example aspects of the present disclosure. The system 600 can provide for managing C2C connectivity limits through the use of an additional layer implemented with a Message Passing Interface (MPI) communication problem. The system 600 can provide improved and theoretically unlimited scalability by connecting an arbitrary number of instances in a standard network cluster. This approach can provide for large-domain simulated bifurcation communication through an additional communication hop with a non-deterministic MPI component.

More particularly, the system includes a driver 602. The driver 602 can be configured to orchestrate the execution of a simulated bifurcation algorithm. For instance, the driver 602 may be implemented at one of the tensor processors in a topology, and/or may be implemented at an additional computing system, such as a controller or central computing system. The driver 602 can communicate with an MPI runtime 604 via API calls. The MPI runtime can provide for message provisioning between a plurality of multi-node runner instances 606(0) to 606(n), referred to collectively as “multi-node runner instances 606” or simply “instances 606.” Some or all of the multi-node runner instances 606 can be or can include a tensor processor, a plurality of tensor processors arranged in a node, and/or other configurations. Some or all of the multi-node runner instances 606 can implement C2C simulated bifurcation as described herein, such as, for example, with respect to FIG. 5. For instance, the MPI runtime can pass a coupling matrix Jₚ₁ . . . . Jₚₙ to each multi-node runner instance 606 and receive, from each instance 606, a corresponding vector output xₚ₁ . . . xₚₙ. In this manner, a plurality of matrix operations can be computed in parallel using tensor processors to efficiently solve NP-hard combinatorial optimization problems.

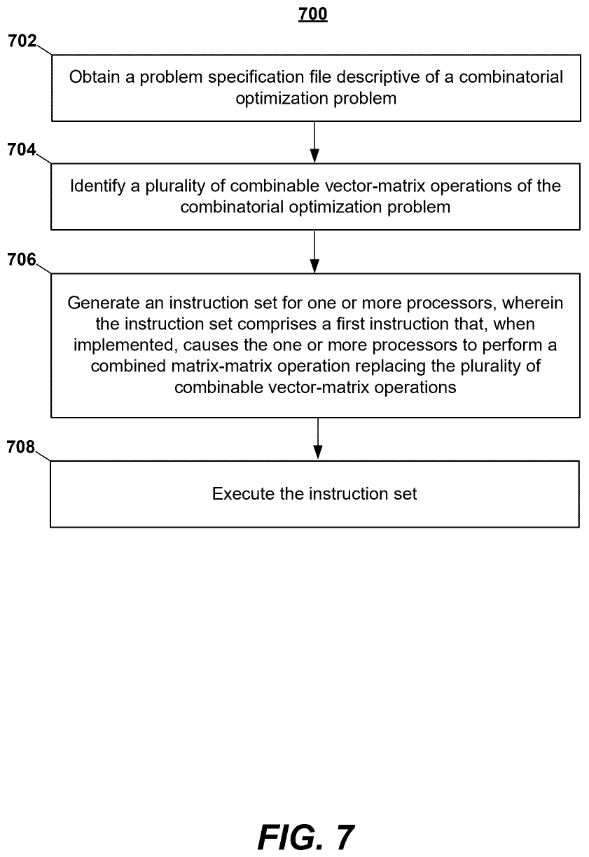

FIG. 7 depicts a flowchart diagram of a method 700 according to example aspects of the present disclosure. One or more portion(s) of the method 700 can be implemented by a computing system that includes one or more computing devices such as, for example, the computing systems described with reference to the other figures (e.g., system 100, system 200, etc.). Each respective portion of the method 700 can be performed by any (or any combination) of one or more computing devices. Moreover, one or more portion(s) of the method 700 can be implemented on the hardware components of the device(s) described herein (e.g., as in FIGS. 1-6, etc.), for example, to validate one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of method 700 can be performed additionally, or alternatively, by other systems.

At 702, the method 700 can include obtaining (e.g., by a computing system including one or more tensor processors) a problem specification file descriptive of a combinatorial optimization problem. For example, the problem specification file can describe the combinatorial optimization problem in a computer-readable format (e.g., a text format, an object-oriented format, or other suitable format). As one example, the problem specification file can be provided by a user or a programmer. As one particular example, in some implementations, the combinatorial optimization problem can be or can include a financial portfolio optimization problem.

At 704, the method 700 can include identifying (e.g., by the computing system) a plurality of combinable vector-matrix operations of the combinatorial optimization problem. For instance, the combinatorial optimization problem can present a number of constraints, and for one or more iterations, performing an algorithm (e.g., a simulated bifurcation algorithm) to solve the combinatorial optimization problem can involve evaluating the constraints. These constraints may frequently be represented by and/or otherwise involve computing multiplication operations between a matrix of values and/or a vector of values. In some implementations, for instance generating the instruction set for the one or more tensor processors can include batching the plurality of combinable matrix-vector operations.

For example, constraints may include a multiplication operation of the form Ax, where A is a multi-dimensional matrix of values, x is a single-dimensional vector of values. One example of this is found in the use of a coupling matrix J in an Ising spin Hamiltonian representation, which is typically multiplied by a number of values. According to example aspects of the present disclosure, a plurality of constraints involving multiplications of Ax can be batched and instead multiplied as AX, where X is a matrix of a plurality of x vectors from various constraints and/or iterations. In this manner, combinable matrix-vector operations can be converted into a single matrix-matrix operation, thereby providing for improved computing resource utilization.

In some implementations, solving the combinatorial optimization problem can include converting the problem specification file from a first representation to a Quadratic Unconstrained Binary Optimization (QUBO) representation. Converting the problem specification file from the first representation to the QUBO representation can involve introducing one or more slack variables to convert an inequality constraint into an equality constraint. For instance, the QUBO representation may not include any inequalities, and the “slack” introduced by inequalities may instead be represented by slack variables, as described further herein.

Furthermore, in some implementations, solving the combinatorial optimization problem can include transforming the QUBO representation to an Ising spin Hamiltonian function. The Ising spin Hamiltonian function can represent a computational problem in its ground state. An Ising model is a mathematical model traditionally used for modeling ferromagnetism in statistical mechanics. The Ising model includes discrete variables that represent magnetic dipole moments of spins (e.g., atomic spins) that can be in one of two states, typically represented as positive one (+1) or negative one (−1). The spins can be arranged in a graph such as a lattice (e.g., where the local structure repeats periodically in all directions), such that each spin interacts with its neighbors. Neighboring spins that agree can have a lower energy than those that disagree, as the system tends to the lowest energy whereas heat disturbs this tendency, thus creating the possibility of different structural phases. As applied to aspects of the present disclosure, the Ising spin Hamiltonian function can be used to model constraints. For instance, consider a set Λ of lattice sites, each with a set of adjacent sites (e.g. a graph) forming a d-dimensional lattice. For each lattice site k∈A there is a discrete variable σₖ such that σk∈{−1, +1}, representing the site's spin. A spin configuration, σ={σₖ}_{K∈Λ} is an assignment of spin value to each lattice site. For any two adjacent sites i, j∈Λ there is an interaction represented by Jᵢⱼ and an external magnetic field hⱼ. The energy of a configuration o can thus be represented by the Hamiltonian function:

$$H ( σ ) = - {\sum }_{〈 i , j 〉} {J}_{ij} {σ}_{i} {σ}_{j} - μ {\sum }_{j} {h}_{j} {σ}_{j}$$

where [symbol] i, j [symbol] represents that i and j are nearest neighbors, and the magnetic moment is represented by p.

Furthermore, in some implementations, solving the combinatorial optimization problem can include mapping the Ising spin Hamiltonian function to an optimization problem over continuous variables by replacing one or more spins (e.g., σ) in the Ising spin Hamiltonian function with harmonic oscillator functions. Any suitable harmonic oscillator function (e.g., a function that experiences a force to return to its original position when displaced, typically proportional to the displacement) can be utilized in accordance with example aspects of the present disclosure.

At 706, the method 700 can include generating (e.g., by the computing system) an instruction set for one or more tensor processors, wherein the instruction set comprises a first instruction that, when implemented, causes the one or more tensor processors to perform a combined matrix-matrix operation replacing the plurality of combinable vector-matrix operations. As one example, a compiler (e.g., the compiler discussed with reference to FIG. 1) can convert the problem specification file to a set of instructions corresponding to steps of an algorithm or program, such as any of the algorithms and/or programs described herein. As one example, according to example aspects of the present disclosure, the compiler can generate a deterministically-scheduled set of instructions that specify, at each instruction, a clock cycle at which an operation will occur, which operation(s) will be performed, which functional unit(s) of the tensor processor will perform the operation, where inputs and/or outputs of the functional units will stream (e.g., along which Superlane), and so on. The instruction set can therefore represent a decomposition of the problem into discrete, scheduled operations that can be efficiently and predictably allocated among the functional units of the tensor processor(s) at compile time.

Additionally and/or alternatively, in some implementations, the instruction set can include a second instruction that, when implemented, causes the one or more tensor processors to stream an output of the combined matrix-matrix operation to a vector multiplication functional unit of the one or more tensor processors. For instance, in some implementations, the instruction set can specify, due to the deterministic nature of the tensor processors, a clock cycle at which the output of the matrix multiplication functional units will be made available, and/or can configure the tensor processor to stream that output to another functional unit on the tensor processor or another tensor processor (e.g., via the C2C links described herein). The output of the combined matrix-matrix operation can be, for example, a partial vector result.

At 708, the method 700 can include executing (e.g., by the computing system) the instruction set. The executing can cause the tensor processors to perform the operations specified by the instruction set utilizing available computing resources (e.g., functional units) of the tensor processors. As one example, executing the instruction set can cause one or more matrix multiplication functional units of the one or more tensor processors to perform the combined matrix-matrix operation. For instance, executing the instruction set can load operands corresponding to the combined matrix-matrix operation (e.g., operands corresponding to the plurality of combinable vector-matrix operations as batched) to be loaded into a data pipeline corresponding to the matrix multiplication functional units. As outputs become available from the matrix multiplication functional units (e.g., according to the deterministically scheduled instruction set), these outputs can be streamed to other functional units, such as the vector multiplication functional units. The results of the computation can be provided to a user, another computing system, or to any other suitable entity. Furthermore, in some implementations, the results of the computation may be continually computed and used to trigger a control action such as, for example, updating a stock portfolio, determining a simulated condition of a physical state of a simulated object, or other suitable application.

One example aspect of the present disclosure relates to a method. The method includes obtaining, by a computing system comprising one or more processors, a problem specification file descriptive of a combinatorial optimization problem. The method includes identifying, by the computing system, a plurality of combinable vector-matrix operations of the combinatorial optimization problem. The method includes generating, by the computing system, an instruction set for the one or more processors, wherein the instruction set includes a first instruction that, when implemented, causes the one or more processors to perform a combined matrix-matrix operation replacing the plurality of combinable vector-matrix operations. The method includes executing, by the computing system, the instruction set.

In some implementations, executing, by the computing system, the instruction set causes one or more matrix multiplication functional units of the one or more processors to perform the combined matrix-matrix operation.

In some implementations, the instruction set includes a second instruction that, when implemented, causes the one or more processors to stream an output of the combined matrix-matrix operation to a vector multiplication functional unit of the one or more processors.

In some implementations, the output of the combined matrix-matrix operation is or includes a partial vector result.

In some implementations, the method further includes converting the problem specification file from a first representation to a Quadratic Unconstrained Binary Optimization (QUBO) representation.

In some implementations, converting the problem specification file from the first representation to the QUBO representation involves introducing one or more slack variables to convert an inequality constraint into an equality constraint.

In some implementations, the method further includes transforming the QUBO representation to an Ising spin Hamiltonian function.

In some implementations, the method further includes mapping the Ising spin Hamiltonian function to an optimization problem over continuous variables by replacing one or more spins in the Ising spin Hamiltonian function with harmonic oscillator functions.

In some implementations, generating, by the computing system, the instruction set for the one or more processors involves batching the plurality of combinable vector-matrix operations.

In some implementations, the combinatorial optimization problem is, includes, and/or otherwise relates to a financial portfolio optimization problem.

Another example aspect of the present disclosure relates to a system. The system includes one or more processors and one or more non-transitory, computer-readable media storing instructions that, when implemented, cause the one or more processors to perform operations. The operations include obtaining a problem specification file descriptive of a combinatorial optimization problem. The operations include identifying a plurality of combinable vector-matrix operations of the combinatorial optimization problem. The operations include generating an instruction set for the one or more processors, wherein the instruction set comprises a first instruction that, when implemented, causes the one or more processors to perform a combined matrix-matrix operation replacing the plurality of combinable vector-matrix operations. The operations include executing the instruction set.

In some implementations, executing the instruction set causes one or more matrix multiplication functional units of the one or more processors to perform the combined matrix-matrix operation.

In some implementations, the instruction set includes a second instruction that, when implemented, causes the one or more processors to stream an output of the combined matrix-matrix operation to a vector multiplication functional unit of the one or more processors.

In some implementations, the output of the combined matrix-matrix operation is or includes a partial vector result.

In some implementations, the operations further include converting the problem specification file from a first representation to a QUBO representation.

In some implementations, converting the problem specification file from the first representation to the QUBO representation comprises involves one or more slack variables to convert an inequality constraint into an equality constraint.

In some implementations, the operations further include transforming the QUBO representation to an Ising spin Hamiltonian function.

In some implementations, the operations further include mapping the Ising spin Hamiltonian function to an optimization problem over continuous variables by replacing one or more spins in the Ising spin Hamiltonian function with harmonic oscillator functions.

In some implementations, generating the instruction set for the one or more processors comprises batching the plurality of combinable vector-matrix operations.

Another example aspect of the present disclosure relates to one or more non-transitory, computer-readable media storing instructions that, when implemented, cause one or more processors to perform operations. The operations include obtaining a problem specification file descriptive of a combinatorial optimization problem. The operations include identifying a plurality of combinable vector-matrix operations of the combinatorial optimization problem. The operations include generating an instruction set for the one or more processors, wherein the instruction set comprises a first instruction that, when implemented, causes the one or more processors to perform a combined matrix-matrix operation replacing the plurality of combinable vector-matrix operations. The operations include executing the instruction set.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A method, comprising:
obtaining, by a computing system comprising one or more processors, a problem specification file descriptive of a combinatorial optimization problem;
identifying, by the computing system, a plurality of combinable vector-matrix operations of the combinatorial optimization problem;
generating, by the computing system, an instruction set for the one or more processors, wherein the instruction set comprises a first instruction that, when implemented, causes the one or more processors to perform a combined matrix-matrix operation replacing the plurality of combinable vector-matrix operations; and
executing, by the computing system, the instruction set.

2. The method of claim 1, wherein executing, by the computing system, the instruction set causes one or more matrix multiplication functional units of the one or more processors to perform the combined matrix-matrix operation.

3. The method of claim 1, wherein the instruction set comprises a second instruction that, when implemented, causes the one or more processors to stream an output of the combined matrix-matrix operation to a vector multiplication functional unit of the one or more processors.

4. The method of claim 3, wherein the output of the combined matrix-matrix operation comprises a partial vector result.

5. The method of claim 1, further comprising converting the problem specification file from a first representation to a Quadratic Unconstrained Binary Optimization (QUBO) representation.

6. The method of claim 5, wherein converting the problem specification file from the first representation to the QUBO representation comprises introducing one or more slack variables to convert an inequality constraint into an equality constraint.

7. The method of claim 5, further comprising transforming the QUBO representation to an Ising spin Hamiltonian function.

8. The method of claim 5, further comprising mapping the Ising spin Hamiltonian function to an optimization problem over continuous variables by replacing one or more spins in the Ising spin Hamiltonian function with harmonic oscillator functions.

9. The method of claim 1, wherein generating, by the computing system, the instruction set for the one or more processors comprises batching the plurality of combinable vector-matrix operations.

10. The method of claim 1, wherein the combinatorial optimization problem comprises a financial portfolio optimization problem.

11. A system, comprising:
one or more processors; and
one or more non-transitory, computer-readable media storing instructions that, when implemented, cause the one or more processors to perform operations, the operations comprising:
obtaining a problem specification file descriptive of a combinatorial optimization problem;
identifying a plurality of combinable vector-matrix operations of the combinatorial optimization problem;
generating an instruction set for the one or more processors, wherein the instruction set comprises a first instruction that, when implemented, causes the one or more processors to perform a combined matrix-matrix operation replacing the plurality of combinable vector-matrix operations; and
executing the instruction set.

12. The system of claim 11, wherein executing the instruction set causes one or more matrix multiplication functional units of the one or more processors to perform the combined matrix-matrix operation.

13. The system of claim 11, wherein the instruction set comprises a second instruction that, when implemented, causes the one or more processors to stream an output of the combined matrix-matrix operation to a vector multiplication functional unit of the one or more processors.

14. The system of claim 13, wherein the output of the combined matrix-matrix operation comprises a partial vector result.

15. The system of claim 11, wherein the operations further comprise converting the problem specification file from a first representation to a QUBO representation.

16. The system of claim 15, wherein converting the problem specification file from the first representation to the QUBO representation comprises introducing one or more slack variables to convert an inequality constraint into an equality constraint.

17. The system of claim 15, wherein the operations further comprise transforming the QUBO representation to an Ising spin Hamiltonian function.

18. The system of claim 15, wherein the operations further comprise mapping the Ising spin Hamiltonian function to an optimization problem over continuous variables by replacing one or more spins in the Ising spin Hamiltonian function with harmonic oscillator functions.

19. The system of claim 11, wherein generating the instruction set for the one or more processors comprises batching the plurality of combinable vector-matrix operations.

20. One or more non-transitory, computer-readable media storing instructions that, when implemented, cause one or more processors to perform operations, the operations comprising:
obtaining a problem specification file descriptive of a combinatorial optimization problem;
identifying a plurality of combinable vector-matrix operations of the combinatorial optimization problem;
generating an instruction set for one or more processors, wherein the instruction set comprises a first instruction that, when implemented, causes the one or more processors to perform a combined matrix-matrix operation replacing the plurality of combinable vector-matrix operations; and
executing the instruction set.
